(19) United States
(12) Patent Application Publication
(10) Pub. No.: US 2018/0144632 A1
(43) Pub. Date: May 24, 2018

(54) REGIONAL AND INDIVIDUAL PARKING SYSTEM AND METHOD

(71) Applicant: MUNI.SPARK LTD, Jerusalem (IL)

(72) Inventors: Itamar Rosen, Tel Aviv (IL); Haim Yosef Gotlieb, Beitar Illit (IL); Orri Ben-Nathan, Tel Aviv (IL)

(73) Assignee: MUNI.SPARK LTD, Jerusalem (IL)

(21) Appl. No.: 15/876,163

(22) Filed: Jan. 21, 2018

Related U.S. Application Data
(63) Continuation of application No. 15/507,125, filed on Feb. 27, 2017, now abandoned.
(60) Provisional application No. 62/042,445, filed on Aug. 27, 2014.

(51) Int. Cl. G08G 1/14; G06Q 10/02; G08G 1/015; G08G 1/13; G06Q 50/26

(52) U.S. Cl. CPC G08G 1/144; G08G 1/147; G08G 1/146; G06Q 50/26; G06Q 10/02; G08G 1/015; G08G 1/13; G08G 1/143

(57) ABSTRACT

A parking system includes a vehicle database, a spot database, a parking event and reservation handler and a violation system. The vehicle database stores vehicle attribute(s). The spot database stores details and attributes of parking spots (on-street and off-street) of a regional authority. The details include a parking space identifier and attribute(s) corresponding to vehicle attribute(s). The spot database enables editing of the spot details and attributes by owners (e.g. the regional authority, lot and private owners) and of parking schemes of groups of spots by the regional authority. The handler receives parking requests which include a destination for a specified vehicle, determines parking spots which are available within a vicinity of a destination and which match the attribute(s) of the vehicle, and reserves a driver's selection of one of parking spots. The violation system receives violation reports from drivers reporting that the reserved parking spot is occupied.

### CROSS REFERENCE TO RELATED APPLICATIONS

This is a Continuation of co-pending U.S. patent application Ser. No. 15/507,125, filed Feb. 27, 2017, which is the US National Stage of International Patent Application No. PCT/IB2015/056512, filed Aug. 27, 2015, and which claimed priority and benefit from U.S. Provisional Patent Application No. 62/042,445, filed Aug. 27, 2014. The foregoing patent applications are incorporated by reference herein in their entirety.

### FIELD OF THE INVENTION

The present invention relates to parking systems generally.

### BACKGROUND OF THE INVENTION

As is well known to drivers, parking in a crowded city is a problem. In many locations, there is a severe shortage of parking spaces. Even when there may be sufficient parking for the overall population of drivers, locating an optimal parking spot with regard to distance from destination, cost and ease of access can be very time consuming. Generally, for the individual driver this means that time is wasted in trying to find a desired parking spot, greater fuel consumption and wear and tear on the vehicle. On the level of the city or state, as vehicles stay on the road longer while trying to find parking, and as traffic often has to slow when a driver tries to enter a parking spot that may be unsuited for his vehicle or his driving skills, traffic congestion is exacerbated. This extra time spent on the roads rather than at work, costs vast sums of money to the local or national economy. Furthermore, this causes additional wear and tear on the road system and is a significant source of air pollution, thus resulting in a reduction of the quality of life, as well as the additional costs of both lost production and medical treatment due to sickness caused by the air pollution.

Available types of parking include spots on the city streets, but finding a parking spot may take a long time, adding significantly to the driving time. Parking in a parking lot or parking garage may be costly, particularly for regular users. Some lots and parking garages are quite large, which can make it difficult to locate the parked vehicle when returning to it. When a lot or garage is close to being full, the many drivers, who are driving around to find a spot, may start arguing over the remaining parking spots.

There have been numerous attempts to solve these problems. Some systems, like Anagog™, StreetLine™ and others, help users find parking spots. Others, like Pang™ and PayByPhone™, help users pay for parking. Still others, like Waze™, help users return to their parked car, while others, like PinkPark™, increase the supply of parking spots with privately-owned parking spots that are “rented out” for public parking.

Other systems, such as those described in US 2004/0068433 to Chatterjee et al, US 2013/0143536 to Ratti and others, attempt to bring the user directly to his parking spot.

### SUMMARY OF THE PRESENT INVENTION

There is provided, in accordance with a preferred embodiment of the present invention, a method of parking including having an identification number associated with each of a plurality of parking spots in a pool of parking spots, for each parking spot, storing ownership information and a set of parking rules having conditions, wherein a portion of the parking rules are defined by an owner of the parking spot, enabling employees of a regional authority to add other parking rules to a group of the parking spots, and determining a set of parking spots from the pool which are available, which are within a vicinity of a destination of a driver and whose conditions apply.

There is also provided, in accordance with a preferred embodiment of the present invention, a method of parking including having a pool of parking spots, the pool including at least on-street parking spots and off-street parking spots, determining a set of parking spots from the pool which are available within a vicinity of a destination of a driver and whose spot details match at least one detail of a vehicle of the driver stored in a vehicle database, providing a selection of parking spots for the driver to choose from, and reserving a selected parking spot for the driver.

Moreover, in accordance with a preferred embodiment of the present invention, the determining includes filtering the set according to driver preferences.

Further, in accordance with a preferred embodiment of the present invention, each parking spot has at least one parking rule associated therewith and each the parking rule has a condition and a parking scheme applicable when the condition applies and wherein the determining includes checking the conditions.

There is also provided, in accordance with a preferred embodiment of the present invention, a method of displaying vehicles registered as parked in an area. The method includes providing a map of the vehicles registered as parked in the area, the map having an indication for each vehicle, and receiving at least one visible detail for each vehicle on the map from a vehicle database, and marking each vehicle indication in the map with the visible detail.

For example, in accordance with a preferred embodiment of the present invention, the visible detail is one of: a color, a manufacturer, a size and a model of the vehicle.

There is also provided, in accordance with a preferred embodiment of the present invention, a citywide parking system. The system includes a spot system to at least store details of parking spots in a pool of parking spots of a municipality, the details including at least a parking spot identification and to enable editing of at least the spot details by owners and of spot parking schemes of groups of spots by city managers, and a parking event and reservation manager at least to receive a destination from a driver, to determine a set of parking spots from the pool which are available, within a vicinity of the destination and whose spot details match at least one detail of a vehicle of the driver stored in a vehicle database, and to reserve a selection from the driver of one of the set of parking spots.

Further, in accordance with a preferred embodiment of the present invention, the vehicle database is in communication with a vehicle registry.

Still further, in accordance with a preferred embodiment of the present invention, the parking event and reservation manager includes a suggestion list builder to generate the set of parking spots.

Moreover, in accordance with a preferred embodiment of the present invention, the suggestion list builder includes a filter to filter the set according to driver preferences.

Additionally, in accordance with a preferred embodiment of the present invention, each parking spot has a size smaller than a standard car and the suggestion list builder generates a set of parking spots, each formed of multiple parking spots according to a size of the vehicle listed in the vehicle database.

Further, in accordance with a preferred embodiment of the present invention, the parking event and reservation manager includes an event database to store parking events and wherein the parking events include at least one of: reservations, parking events, parking releases and violations.

Still further, in accordance with a preferred embodiment of the present invention, the parking scheme is one of: free, paid and based on supply and demand.

Moreover, in accordance with a preferred embodiment of the present invention, the parking scheme defines duration of parking and wherein the duration is one of: fixed, based on supply and demand and having a minimum or maximum time.

Further, in accordance with a preferred embodiment of the present invention, the parking event and reservation manager includes unit to receive the destination from one of: a car computer application, a smart phone application, a tablet, a website, an SMS (short message system) message, an IVR (interactive voice response) system, a call center, a parking station and a parking steward or warden.

Still further, in accordance with a preferred embodiment of the present invention, the parking event and reservation manager is in communication with a navigation system to navigate the driver to and/or from the reserved parking spot.

Additionally, in accordance with a preferred embodiment of the present invention, the parking event and reservation system includes unit to provide at least one visible detail from the vehicle database of vehicles currently registered as parking in the vicinity of the reserved parking spot to display to the driver in association with their parking locations.

Moreover, in accordance with a preferred embodiment of the present invention, the visible detail is other than a license plate number. The visible detail can be color, manufacturer and model.

Further, in accordance with a preferred embodiment of the present invention, the spots have changeable statuses and wherein the status is at least one of the following: reserved, suggested, occupied, and ReservedByGroup.

Still further, in accordance with a preferred embodiment of the present invention, the owners include the municipality and at least one of: lot owners and private owners.

There is also provided, in accordance with a preferred embodiment of the present invention, a citywide parking system. The system includes a parking event and reservation manager at least to receive a destination from a driver, to determine a set of parking spots from the pool which are available, within a vicinity of the destination and whose spot details match at least one detail of a vehicle of the driver stored in a vehicle database, and to reserve a selection from the driver of one of the set of parking spots, a suggestion list builder to generate the set of parking spots, and a rule editor for enabling editing of parking rules for each the parking spot, wherein each the parking rule has a condition and a parking scheme applicable when the condition applies and wherein the suggestion list builder includes a condition checker.

Further, in accordance with a preferred embodiment of the present invention, the condition is defined by at least one of: information about the spots, information about the vehicle, driver preferences, time, duration and group rules applying to groups of spots.

Still further, in accordance with a preferred embodiment of the present invention, the rules have priorities associated therewith and the suggestion list builder considers the priorities in determining the order in which the rules are applied.

Moreover, in accordance with a preferred embodiment of the present invention, the suggestion list builder includes a segment list builder to build a segment list of all applicable rules wherein a later applicable rule replaces an earlier applicable rule for the time period to which it applies.

Further, in accordance with a preferred embodiment of the present invention, the rule editor includes a priority editor accessible by employees of a regional authority for groups of spots.

Still further, in accordance with a preferred embodiment of the present invention, the group rules pertain to at least one of: residents, disabled, loading and unloading, VIP and embassy parking.

There is also provided, in accordance with a preferred embodiment of the present invention, a parking system. The system includes a parking event and reservation manager at least to receive a destination from a driver, to determine a set of parking spots from a pool of parking spots in a region which are available, within a vicinity of the destination and whose spot details match at least one detail of a vehicle of the driver stored in a vehicle database, and to reserve a selection from the driver of one of the set of parking spots, and a violation system in communication with a region violation system to receive violation reports at least from drivers, to provide a map to a parking warden with visual indications of vehicles in spots registered as Occupied in a spot database in a predetermined geographical area and to receive an indication from the warden of a currently available spot that is currently registered as being occupied.

Further, in accordance with a preferred embodiment of the present invention, the violation system includes unit to receive a report reporting that the reserved parking spot is occupied and to update a reputation indication of the driver upon receipt of a violation authorization from the parking warden.

Still further, in accordance with a preferred embodiment of the present invention, the violation system includes unit to activate the parking event and reservation manager to provide a new parking spot to the driver when the driver reports that the selected parking spot is occupied.

Moreover, in accordance with a preferred embodiment of the present invention, the violation system includes unit to show a city warden at least one visible detail from the vehicle database of vehicles currently registered as parking in the vicinity of the parking warden.

Further, in accordance with a preferred embodiment of the present invention, the method includes redirecting a driver whose parking spot is occupied by a violator, to a different parking spot. For example, it can include redirecting a driver to an alternate location fitting his needs.

Still further, in accordance with a preferred embodiment of the present invention, the method can include reminding a driver to move the vehicle, before the time to park finishes, and/or offering time extensions to the driver.

Additionally, in accordance with a preferred embodiment of the present invention, the method also includes receiving status information from the driver via one of: the driver and a GPS indication.

Moreover, in accordance with a preferred embodiment of the present invention, the method also includes storing queue information when a driver's request cannot be fulfilled.

Further, in accordance with a preferred embodiment of the present invention, the parking event and reservation manager includes an analyzer to generate at least one of the following statistics: waiting time for allocation of a cell, number of cells available, expected costs of parking and demand at a given time, etc.

Still further, in accordance with a preferred embodiment of the present invention, the parking event and reservation manager includes an analyzer to generate at least one of the following statistics: real-time updates of parking status for all parking spots in the region, real-time updates of supply and demand for parking, and offline statistical analysis of past parking behavior.

Moreover, in accordance with a preferred embodiment of the present invention, the system includes a unit to distribute revenues from parking violations at least between a regional authority and the person offended by the violation.

There is also provided, in accordance with a preferred embodiment of the present invention, a parking system, the system including a vehicle database of vehicle data including at least one vehicle attribute, a spot database storing details and attributes of parking spots in a pool of parking spots of a regional authority, the pool including at least on-street parking spots and off-street parking spots, and the details including at least a parking space identifier and at least one attribute of a type corresponding to the at least one vehicle attribute of the vehicle data, the spot database enabling editing of at least the spot details and attributes by owners and of spot parking schemes of groups of spots by the regional authority, where the owners include at least the regional authority and at least one of: lot owners and private owners of individual spots. The system also includes a parking event and reservation handler for at least receiving parking requests which include for a specified vehicle at least a destination, determining a set of parking spots from the pool which are available within a vicinity of a destination of a driver and which match the at least one attribute of the vehicle, providing the set of parking spots to the driver for his selection and reserving a selection by the driver of one of the set of parking spots for the driver. The system also includes a violation system in communication with a city violation system for receiving violation reports at least from drivers reporting that the reserved parking spot is occupied.

There is also provided, in accordance with a preferred embodiment of the present invention, in a region having a plurality of vehicle parking spots having default rules conditioning their use by vehicle drivers, a method of managing parking within the region. The method includes selectably overriding at least some of the default rules including having a pool of parking spots in a region having default rules conditioning their use by vehicle drivers, the rules being operated by a regional authority and the pool including separately owned parking spots that are owned by owners other than the regional authority, including maintaining a spot database storing details and attributes of at least on-street parking spots and off-street parking spots, the details including at least a physical attribute of the parking spot and an identifier, for each parking space, storing ownership information and a set of parking rules having conditions for application of the parking rules, wherein a portion of the parking rules are defined by an owner of the parking space, enabling the regional authority to add other parking rules to a group of the separately owned parking spots, receiving parking requests which include for a specified vehicle at least a destination, determining a set of parking spots from the pool which are available within the vicinity of a destination of a driver and whose spot details match at least one attribute of a vehicle of the driver stored in a vehicle database, maintaining an editable rule database storing current rules defining current conditions for use of the parking spots, receiving parking requests from drivers of the vehicles and applying the current rules in handling the requests, each request including, for a specified vehicle, at least a destination and at least one driver preference, determining, irrespective of the ownership of the parking spots, a set of parking spots from the pool which are currently available within a vicinity of a destination of a driver and which are suitable for the vehicle and match the at least one driver preference, receiving and reserving a selection by the driver of one of the set of parking spots for the driver, and using at least one communications network for communicating data among the vehicle database, the spot database, the rule database, the parking event and reservation handler and the drivers so as to receive and process the requests. The method also includes in the event of failure of at least a portion of the at least one communication network, cancelling the current rules and applying the default rules.

There is also provided, in accordance with a preferred embodiment of the present invention, a parking system, the system including a vehicle database of vehicle data including at least one vehicle attribute, a spot database storing details and attributes of parking spots in a pool of parking spots in a region, the details including at least a parking space identifier and at least one attribute of a type corresponding to the at last one vehicle attribute of the vehicle data, and a parking event and reservation handler for at least receiving parking requests which include for a specified vehicle at least a destination, for determining a set of parking spots from the pool which are available within a vicinity of a destination of a driver and which match the at least one attribute of the vehicle, and for reserving a selection by the driver of one of the set of parking spots for the driver.

There is also provided, in accordance with a preferred embodiment of the present invention, a method of parking including having a pool of parking spots in a region, the pool including at least on-street parking spots and off-street parking spots, receiving parking requests which include for a specified vehicle at least a destination, determining a set of parking spots from the pool which are available within the vicinity of a destination of a driver and whose spot details match at least one attribute of a vehicle of the driver stored in a vehicle database, providing the set of parking spots to the driver for his selection, and reserving a selected parking spot for the driver.

There is also provided, in accordance with a preferred embodiment of the present invention, a parking system, the system including a vehicle database storing vehicle data from a vehicle registry, a spot database storing details and attributes of parking spots in a pool of parking spots, the details including at least a physical attribute of the parking spot and an identifier, a rule database storing rules defining the conditions for use of the parking spots, and a parking event and reservation handler for at least receiving parking requests including, for a specified vehicle at least a destination, for determining a set of parking spots from the pool which are available within a vicinity of a destination of a driver and which are suitable for the vehicle, and for reserving a selection by the driver of one of the set of parking spots for the driver.

Moreover, in accordance with a preferred embodiment of the present invention, the parking requests also include a least one driver preference, and the determined parking spots also match the at least one driver preference.

There is also provided, in accordance with a preferred embodiment of the present invention, a regional parking system including a spot system for at least storing details and attributes of parking spots in a pool of parking spots of a regional authority, the details including at least a parking spot identifier, a parking event and reservation manager at least for receiving a destination of a driver, for determining a set of parking spots from the pool which are available within the vicinity of the destination and whose spot details match at least one detail of a vehicle of the driver stored in a vehicle database, and for reserving a selection by the driver of one of the set of parking spots, and a violation system in communication with a city violation system for receiving violation reports at least from drivers reporting that the reserved parking spot is occupied.

Further, in accordance with a preferred embodiment of the present invention, the violation system is also operative to update a reputation indication of the driver upon receipt of a violation authorization from a city warden.

There is also provided, in accordance with a preferred embodiment of the present invention, a method of reducing vehicle-related crime including having a pool of parking spots in a region, receiving a parking request from a driver which include for a specified vehicle at least a destination, determining a set of parking spots from the pool which are available within the vicinity of a destination of a driver and whose spot details match at least one attribute of a vehicle of the driver stored in a vehicle database, providing the set of parking spots to the driver for his selection, making a reservation of a selected parking spot for the driver, and providing details of the reservation to a law enforcement agency.

There is also provided, in accordance with a preferred embodiment of the present invention, in a region having a plurality of vehicle parking spots having default rules conditioning their use by vehicle drivers, a method for selectably overriding at least some of the default rules, the method including having a vehicle database storing vehicle data from a vehicle registry, maintaining a spot database storing details and attributes of parking spots in a pool of parking spots in the region, the details including at least a physical attribute of the parking spot and an identifier, maintaining an editable rule database storing current rules defining current conditions for use of the parking spots, maintaining a parking event and reservation handler at least to receive parking requests from drivers of the vehicles and for applying the current rules in handling the requests, each request including, for a specified vehicle, at least a destination and at least one driver preference, to determine a set of parking spots from the pool which are currently available within a vicinity of a destination of a driver and which are suitable for the vehicle and match the at least one driver preference, and to make a reservation of a selection by the driver of one of the set of parking spots for the driver, using at least one communications network for communicating data among the vehicle database, the spot database, the rule database, the parking event and reservation handler and the drivers so as to receive and process the requests, and in the event of failure of at least a portion of the at least one communication network, cancelling the current rules and applying the default rules.

There is also provided, in accordance with a preferred embodiment of the present invention, a regional parking system including a spot system for at least storing details and attributes of parking spots in a pool of parking spots of a regional authority, the details including at least a parking spot identifier, and for enabling editing of at least the spot details and attributes by owners and of spot parking schemes of groups of spots by the regional authority, where the owners include at least the regional authority and at least one of: lot owners and private owners of individual spots, a parking event and reservation manager at least for receiving a destination of a driver, for determining a set of parking spots from the pool which are available within the vicinity of the destination and whose spot details match at least one detail of a vehicle of the driver stored in a vehicle database, and for reserving a selection by the driver of one of the set of parking spots.

There is also provided, in accordance with a preferred embodiment of the present invention, a method of parking including having an identifier associated with each of a plurality of parking spots in a pool of parking spots in a region whose parking rules are operated by a regional authority, the pool including separately owned parking spots that are owned by owners other than the regional authority, for each parking space, storing ownership information and a set of parking rules having conditions for application of the parking rules, wherein a portion of the parking rules are defined by an owner of the parking space, enabling the regional authority to add other parking rules to a group of the separately owned parking spots, and determining a set of parking spots from the pool which are available, which are within a vicinity of a destination of a driver and whose conditions apply, irrespective of the ownership of the parking spots.

There is also provided, in accordance with a preferred embodiment of the present invention, in a region having a pool of parking spots managed by a parking system and previously un-monitored parking spots not managed by the parking system, a method of incorporating the un-monitored parking spots so as to become managed by the parking system and thus increase the number of managed parking spots, the method including mapping at least one previously un-monitored parking spot, assigning an identifier to the at least one previously un-monitored parking spot, evaluating selected details and attributes of the at least one previously un-monitored spot, and adding the details and attributes of the at least one previously un-monitored spot to a spot database in which are stored details and attributes of parking spots in the pool of parking spots, thereby increasing the number of managed parking spots.

There is also provided, in accordance with a preferred embodiment of the present invention, a method of displaying vehicles parked in an area, the method including providing a map of the vehicles parked in the area, the map having an indication for each vehicle, and receiving at least one visible detail for each vehicle on the map from a vehicle database, and marking each vehicle indication on the map with the visible detail.

There is also provided, in accordance with a preferred embodiment of the present invention, a method of reducing traffic related pollution in a region including having a pool of parking spots in a region, receiving a parking request from at least one driver of a vehicle, the parking request including at least a destination, determining a set of parking spots from the pool in accordance with a number of factors which include proximity to the destination, and spots having a location which will require a minimal driving time of the vehicle, thereby providing minimal air pollution by the vehicle, providing the set of parking spots to the driver for his selection, and reserving a selected parking spot for the driver.

Further, in accordance with a preferred embodiment of the present invention, the region is a venue with poor ventilation.

Still further, in accordance with a preferred embodiment of the present invention, the method also includes the step of receiving information regarding traffic patterns in an area proximate to the destination, and wherein the step of determining includes minimizing the slowing effect of the vehicle on the traffic in the area proximate to the destination, thereby minimizing air pollution caused by the vehicle in the area proximate to the destination.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an exemplary pictorial illustration of numbered on-street parking, useful in understanding the operation of the present invention;

FIG. 2 is a block diagram illustration of a parking system, constructed and operative in accordance with a preferred embodiment of the present invention;

FIG. 3A is an exemplary suggested parking spot list, useful in understanding the system of FIG. 2;

FIG. 3B is an exemplary screen shot for a driver to indicate that s/he has parked;

FIG. 3C is an exemplary screen shot for a driver to indicate that s/he has left his/her parking spot;

FIGS. 4A and 4B are exemplary listings of a vehicle table and a vehicle attribute table respectively;

FIG. 4C is an exemplary listing of possible vehicle attributes;

FIG. 4D is an exemplary illustration of a unique ID representation table;

FIGS. 5A and 5B are exemplary listings of a spot table and a spot attribute table respectively;

FIG. 5C is an exemplary listing of possible spot attributes;

FIG. 5D is an exemplary listing of a spot status table;

FIG. 6 is an exemplary listing of an event history table;

FIG. 7A is an exemplary listing of rules table;

FIG. 7B is a table of three exemplary rules;

FIG. 8A is a method for receiving and storing a driver's spot selection;

FIG. 8B is a method for receiving and storing a driver's indication that s/he has parked;

FIG. 8C is a method for receiving and storing a driver's indication that s/he has left the parking spot;

FIG. 9A is a flow chart illustration of the operation of a suggestion list builder, forming part of the system of FIG. 2, constructed and operative in accordance with a preferred embodiment of the present invention;

FIG. 9B is a graphical illustration showing how parking segments are added together;

FIGS. 9C and 9D are flow chart illustrations of methods forming part of the suggestion list builder of FIG. 9A;

FIG. 10A is an exemplary listing of a spot group table;

FIGS. 10B and 10C, are flow chart illustrations of a method for initializing a group reservation and a method for handling a group reservation, respectively;

FIGS. 11A and 11B are an exemplary listing of a queue table and a periodic process for reviewing queued requests, respectively;

FIG. 12 is a flow chart of an operation of violation system for a warden;

FIGS. 13A and 13B are exemplary screenshots for private spot manager and lot spot manager, respectively;

FIGS. 13C and 13D are exemplary screenshots of a spot editor and a rules editor, respectively;

FIG. 13E is an exemplary screenshot of a city control center 151;

FIG. 14 is an exemplary listing of the rules of FIG. 7B with a city override rule; and

FIG. 15 is a pictorial illustration of a map around the destination showing the suggested parking spots, useful in understanding the operation of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

DEFINITIONS: In the present document, unless specified otherwise, the following definitions apply:

“Region” means any geographical area having a network of roads as well as any or all types of parking spot, including on-street, off-street, parking lots, multi-story parking garages; owned by one or more of a variety of owners including municipal/city, private lot owners, including such lots which may serve venues such as airports, sporting event locations and shopping malls.

“City” is used interchangeably with “region” unless specified otherwise.

“Destination” means a place where a driver wishes to be, including a place where he wishes to travel to and a place where he is already located at the time of entering a request for parking.

“Vehicle Attribute” means any data referring to a vehicle which may affect its suitability for parking in a specified parking spot, including but not limited to technical data of the vehicle, for example, physical dimensions; type of operating system, for example, gasoline, hydrogen; and legal status, for example, private, emergency, government, security, diplomatic.

“Vehicle” means any wheeled conveyance used for on or off road transportation and for which parking may be required including, but not limited to, automobiles, bicycles, tricycles, motorbikes, buses, trucks, emergency vehicles, security vehicles, industrial vehicles, public transportation vehicles.

“Driver” means a vehicle operator or vehicle passenger or other individual interacting with the system for the purpose of reserving a parking spot for a specified vehicle.

Applicants have realized that problems of prior art are overcome by taking a citywide or regional approach to the challenge of parking, taking into account not only specific needs of drivers regarding their desire to park as close as possible to a venue, but also taking into account various factors such as how traffic in the area of their venue may be influenced by their parking in one specific spot or another. This influences the time wasted in traffic jams and cost to the local economy, vehicle-related air pollution, medical costs and lost work productivity caused by pollution-related disease, and wear and tear on both the vehicles and the road system. Preferably, a system implementing this approach will be accessible to all drivers, whether local or from outside the regions, regardless of type of vehicle and frequency of parking, and whether the drivers possess smartphones, non-smart mobile phones, or no phone at all.

A major problem contributing to the shortage of available parking and to the cost of providing temporary parking solutions such as during mass events such as demonstrations and sporting events, is the manner in which parking rules are currently designated and implemented. As known, due to the fact that parking permissions (for example, paid parking, no parking, limited parking, reserved parking and so on) are implemented by permanent means such as by street signs and painted signs, or other permanent means such as parking meters, little or no flexibility exists when it is sought to temporarily change parking permissions.

Applicants have thus further realized that a citywide or regional, programmable parking management system will be able to solve the above problems, increasing the availability of parking spots generally by programmatically changing their designation from a fixed designation, such as described above, to a designation which is temporary, and which can be changed in accordance with current needs, traffic patterns, emergencies and other dynamic circumstances requiring a flexible, dynamic response.

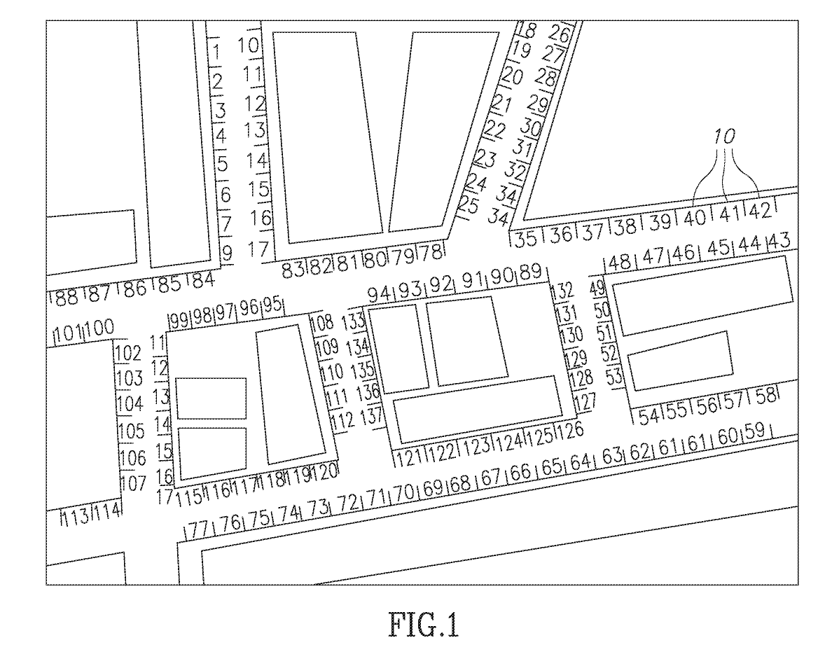

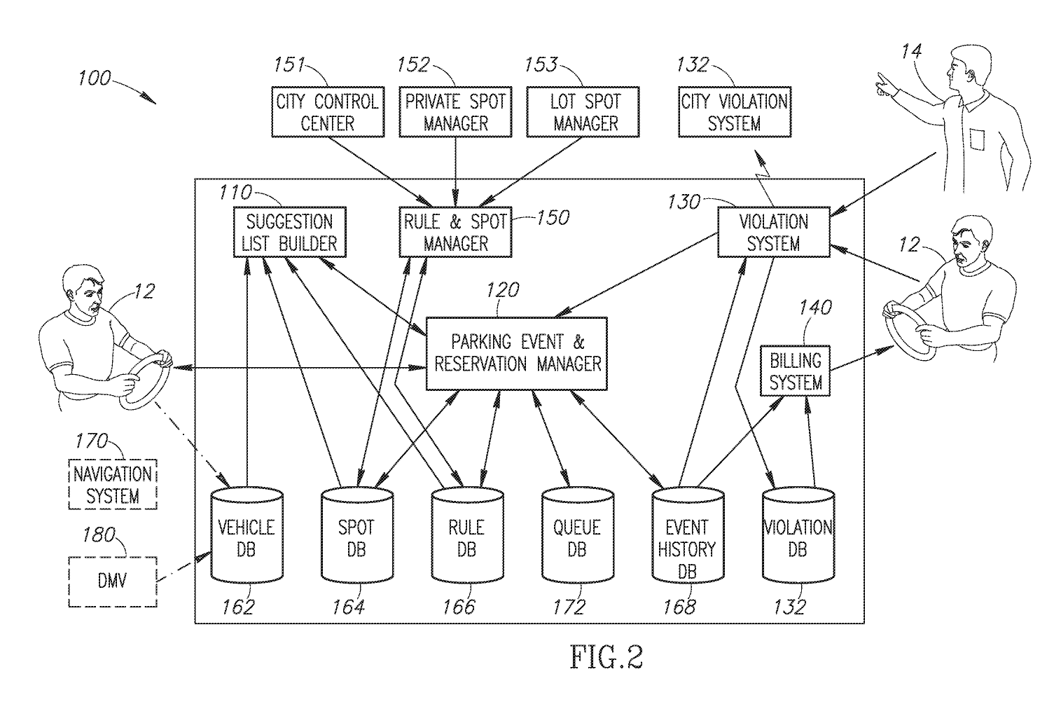

As shown in FIG. 1, to which reference is now made, in accordance with a preferred embodiment of the present invention, every parking spot 10 in a region, such as in a city, whether in a lot or parking garage, on a street (as shown) or privately-owned, may be provided with a visible identifier, such as numbers as shown, and may be managed via an exemplary system 100 shown in FIG. 2, to which reference is now made. In response to a destination input by a driver, system 100 may suggest a selection of parking spots that meet the driver's parking needs and may reserve the selected spot for the driver.

System 100 may comprise a suggestion list builder 110, a parking event and reservation manager 120, a violation system 130 and a billing system 140. In accordance with a preferred embodiment of the present invention, system 100 may also comprise a rule and spot manager 150 which may operate with a city control center 151, a private spot manager unit 152 and a lot spot manager unit 153. System 100 may also comprise multiple logical databases, such as a vehicle database 162, a spot database 164, a rule database 166, an event history database 168 and an optional queue database 172 which are controlled and updated by elements 110, 120, 130, 140 and 150.

An example of use of the system from the side of a vehicle operator or driver, may be as follows: At any time, although typically at the beginning of a journey, a driver 12 may connect to parking event and reservation manager 120 via any suitable means, such as, but not limited to, an “App” on a smartphone, a tablet, a website, a car computer application, sending an SMS to a designated telephone number, a public or private telephone, an IVR (integrated voice response) system, a call center, parking stations, etc., and may provide at least a destination and a license plate number of the vehicle wishing to park. In addition, driver 12 may input any preferences s/he may have, such as for a covered parking spot, or one with an electric charging facility.

Parking event and reservation manager 120 may send the driver's request to suggestion list builder 110 which, in turn, may determine a list of suggested available parking spots for driver 12 in the general vicinity of the destination, in accordance with the vehicle attributes (see below) and in accordance with any preferences that may have been specified by the driver. Parking event and reservation manager 120 may provide this list to driver 12.

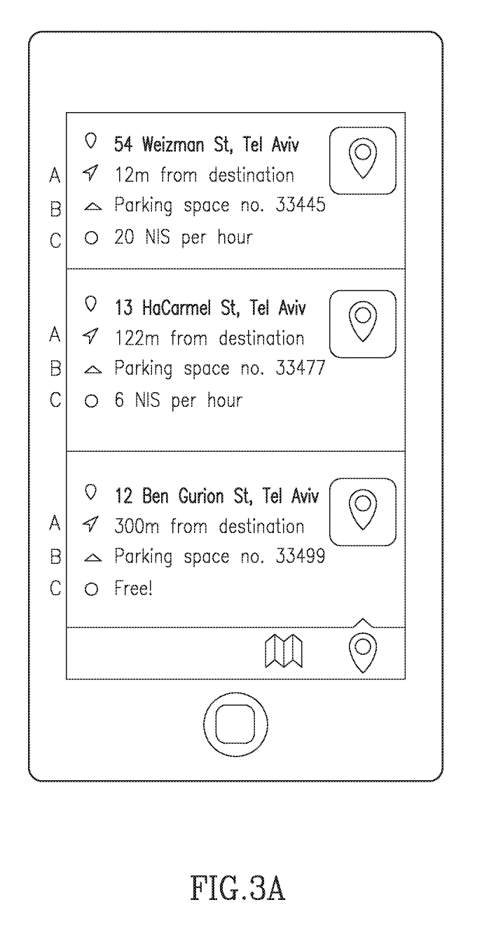

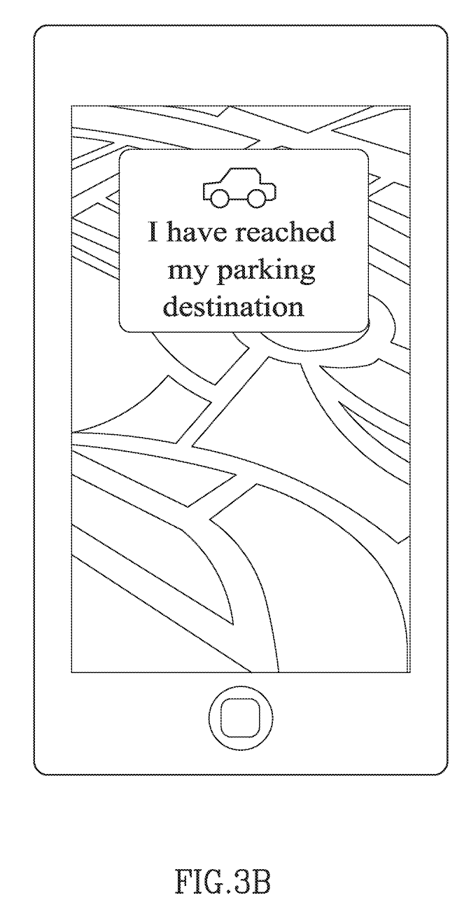

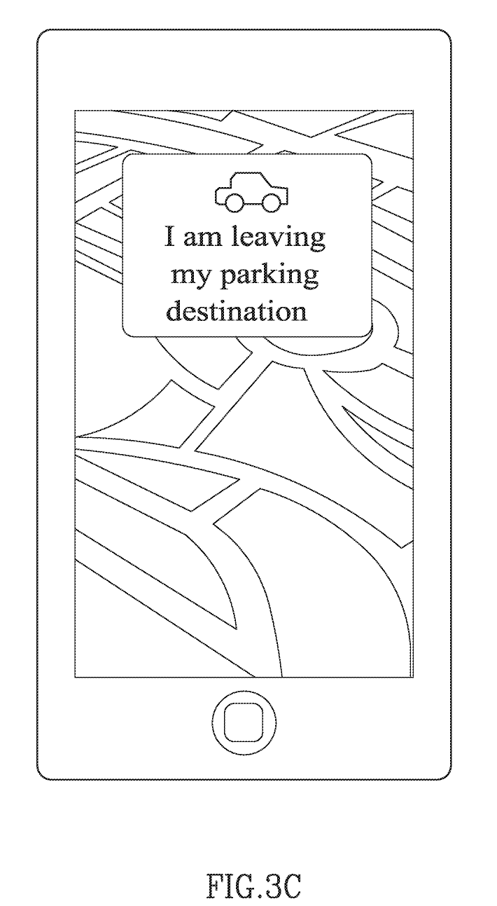

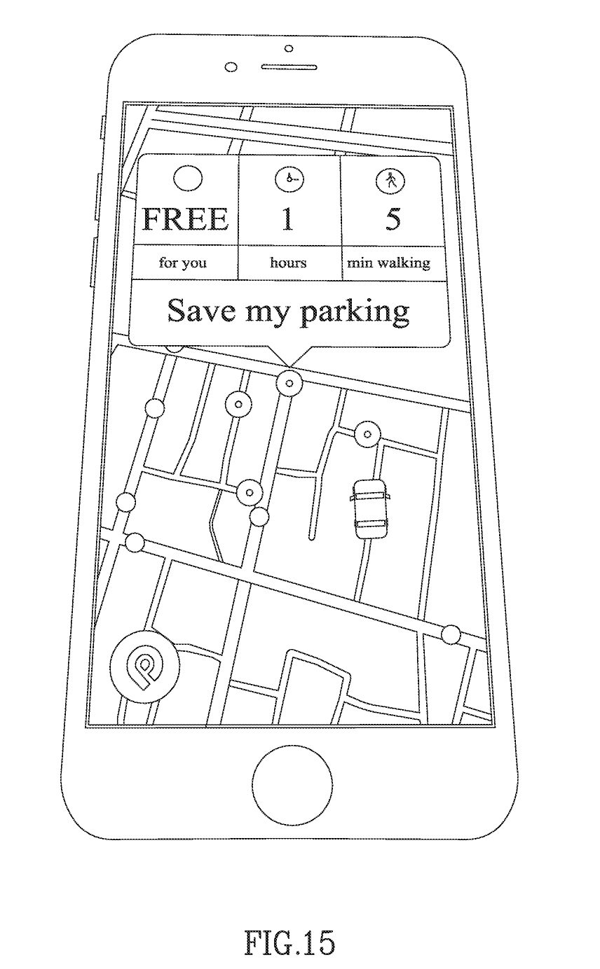

FIG. 3A, to which reference is now briefly made, is an exemplary suggested parking spot list, showing three suitable spots which are currently available. For each one, relevant information is provided, such as its distance (A) from destination, the spot number (B), and its price (C) per hour. Other relevant information may also be listed so that the user may select a spot which suits him/her best. In an alternative embodiment, the list may be presented in any suitable manner, including on a map around the destination, as shown in FIG. 15, and showing each suggested spot at its location on the map. When driver 12 clicks upon a spot, the relevant information may be provided, where different indications may indicate pricing levels, such as free or not free.

Parking event and reservation manager 120 may register the selection in event history database 168 and may indicate to spot database 164 that the spot is now reserved for the vehicle provided in the initial parking request. Parking event and reservation manager 120 may provide the location information of the selected spot (such as its latitude and longitude) to an external navigation system 170, such as the Waze navigation system commercially available from Google of the USA or any navigation system chosen by driver 12. Navigation system 170 may guide driver 12 directly into the reserved parking spot, at which point, driver 12 may indicate to parking event and reservation manager 120 that s/he has parked. An exemplary screen shot for this instruction is shown in FIG. 3B, to which reference is now briefly made.

In response, parking event and reservation manager 120 may update spot database 164 that the reserved spot, of driver 12, is now “occupied” and may also indicate to event history database 168 that parking has started.

In one embodiment, driver 12 may utilize navigation system 170 or any other suitable navigation system for walking, for navigation back to his/her parking spot. At this point, driver 12 may indicate to parking event and reservation manager 120 that s/he has left the parking spot. An exemplary screen shot for this instruction is shown in FIG. 3C, to which reference is now briefly made.

On receipt of an indication that the vehicle has left the parking spot, parking event and reservation manager 120 may update spot database 164 that the occupied spot, of driver 12, is now “available” and may also indicate to event history database 168 that parking has ended. This may provide a trigger to billing system 140 to display the cost of this parking event to driver 12. Billing system 140 may also periodically review event history database 168 to produce billing reports to drivers 12.

Optionally, parking event and reservation manager 120 may operate a queue, via queue database 172, whenever parking event and reservation manager 120 does not produce a parking spot for a given driver's request.

Violation system 130 may receive a report from driver 12 if s/he discovers that his/her reserved spot is occupied. This driver-reporting of violations enables system 100 to oversee itself. Violation system 130 may also receive inputs from wardens 14 (FIG. 2) who may visit the parking spots for violations. In accordance with a preferred embodiment of the present invention, wardens 14 may alternatively visit empty parking spots for unreported available parking spots (i.e. if driver 12 forgot to report that s/he left the parking spot). Violation system 130 may transmit reports to an external violation system 132, such as of a city, to fine the violator according to municipal rules.

In accordance with an alternative embodiment of the present invention, violation system 130 may receive information from a driver regarding the parking status of adjacent parking spots (occupied or free).

In one embodiment of the present invention, violation system 130 may also indicate to billing system 140 to credit driver 12 for reporting the violation. For example, the credit might be a percentage of the fine from the violator and/or the fine may be divided among the reporting driver, the city and/or the owner of the spot.

Violation system 130 may also indicate to parking event and reservation manager 120 to find an alternative parking spot for driver 12. This may be done by providing a high priority to such a request, as described in more detail hereinbelow.

Rule and spot manager 150 may manage the spots and may input the spot information into spot database 164, storing information about the spots, and rule database 166, storing the multiple rules governing the operation of each spot. In accordance with a preferred embodiment of the present invention, non-municipal owners of parking spots, such as parking lot and parking garage owners, as well as private owners of individual parking spots such as driveways to private residences or the like, may add their parking spots to the set of municipal parking spots, so that suggestion list builder 110 may select any spot, regardless of the type of ownership, for suggestion to a driver.

Lot and garage owners may utilize lot spot manager 153 to enter, update and control their spots, while private owners may utilize private spot manager 152 for the same purpose. Owners may not only list their spots (including the spot location and its various attributes, described in more detail hereinbelow), but they may also define rules, described in more detail hereinbelow, for the spots. For example, a private spot owner may only want to “rent out” his spot during the hours s/he is at work and may thus define an appropriate rule saying that the spot is available only during those hours.

City control center 151, in addition to enabling city workers to enter and update municipal parking spots (both on-street spots and those in municipal lots), may also enable them to enter municipal demands or requirements, such as giving priority to city residents, priority according to the distance of the journey of the person wishing to park, priority to invalid vehicles, parking rules designated to facilitate street cleaning, etc., as well as sporadic or sudden demands, such as those occasioned by the visit of a VIP, an emergency situation, or any temporary change in traffic patterns that may be determined to influence parking.

It will be appreciated that system 100 is operative to assist in the efficient management of parking, balancing the needs of individual drivers with both regional traffic and other municipal demands. The present invention may also solve many of the parking problems which a city has, such as traffic congestion at least partially due to drivers looking for parking spots, air pollution as such drivers circulate, looking for parking spaces, inefficient use of parking spaces, etc.

As mentioned hereinabove, system 100 may be accessible to all types of drivers and may not require any pre-registration or “login”. Instead, vehicle information may be downloaded from a governmental vehicle registry, such as that of a Department of Motor Vehicles (DMV) 180, leaving driver 12 just to provide the license plate information of the vehicle s/he is currently driving.

It will be appreciated that, with system 100, no parking meters are necessary, nor are any gates to any parking lot or garage. System 100 requires less supervision and eliminates over- and under-payments, such as occur with parking meters Likewise, the problem of finding where a vehicle is parked is avoided. System 100 allows for increased utilization of both public and private parking resources and flexibility in managing parking spots. This includes altering the nature of the parking spot, such as defining when the spot is available for parking, assignation of a spot as being for disabled parking, for residents and/or visitors. The system of the invention is also able to dynamically change the cost of use of any given spot, including the provision of free parking, and to enable advance reservation of a spot.

It will furthermore be appreciated that the present invention does not require sensors to determine the parking status of a parking spot, although it may optionally be operated in conjunction with any existing sensor system, which may provide parking event information to parking event and reservation manager 120.

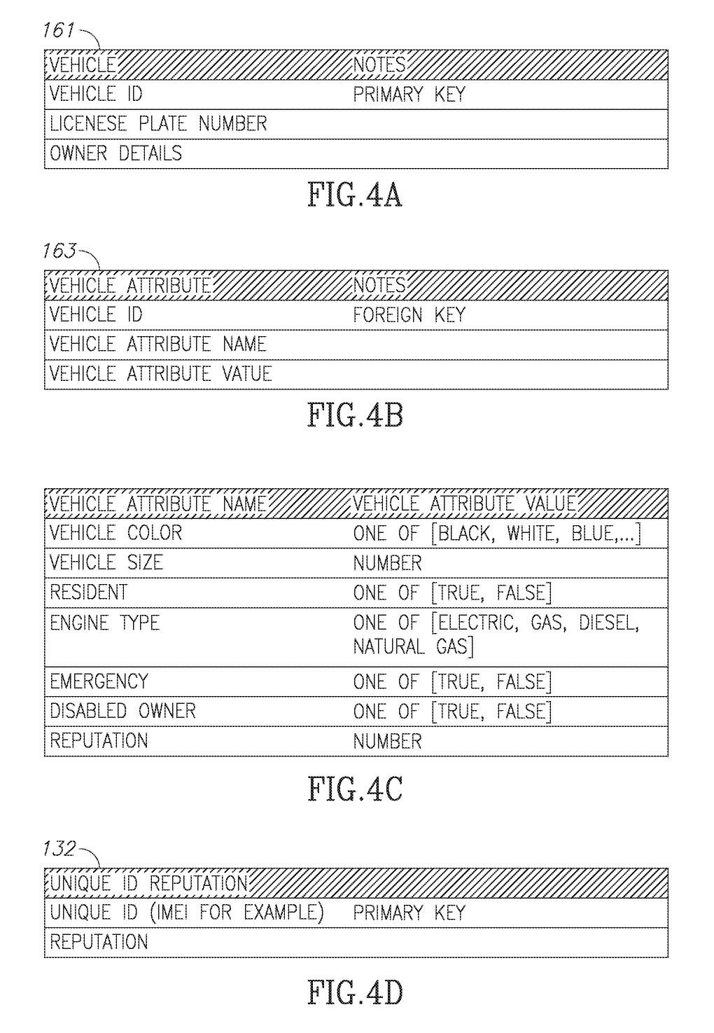

Reference is now made to FIGS. 4A and 4B, which illustrate a vehicle table 161 and a vehicle attribute table 163, together forming vehicle database 162, and to FIG. 4C, which is an exemplary listing of possible vehicle attributes, useful in understanding vehicle attribute table 163. Vehicle table 161 may comprise one record per vehicle, where each record may comprise a vehicle identification (ID) of some kind, a license plate number and owner details, such as name, address, etc.

Vehicle attribute table 163 may comprise multiple records per vehicle, where each record may comprise a vehicle ID as a “foreign key” (i.e. pointing to the vehicle ID record in vehicle table 161), an attribute and a value of the attribute. There may be multiple attributes per vehicle and there may be multiple types of attributes. FIG. 4C lists a few exemplary attributes, such as vehicle color, engine type, a special status for example an emergency vehicle, if it belongs to a disabled person, if it belongs to a municipal resident. Further attributes may be size, which may be defined as belonging to one of a predefined set of sizes (such as truck, large, compact, motorcycle, etc.) to match multiple sized parking spots. Other attributes might be the manufacturer and model of the vehicle and a reputation for the vehicle. It will be appreciated that most of the information stored in tables 161 and 163 is generally information collected by a governmental vehicle registration body, such as DMV 180.

FIG. 4D illustrates a unique ID representation table 132, which may form part of violation system 130 to keep track of drivers 12 who have had violations reported about them and of drivers 12 who have reported violations. This violation reporting may define a “reputation” of each driver 12 which violation system 130 may track and may provide to billing system 140 when providing credits and/or to parking event and reservation manager 120 when a driver 12 may attempt to reserve a parking spot. In this way, system 100 may act to restrict repeat violators or to charge them extra, or to punish them in any suitable manner.

FIG. 4D stores a unique ID for each driver 12 as well as the associated reputation of the driver. One unique ID might be the IMEI (international mobile station equipment identity code of the driver's cellphone. Another might be an ANDROID_ID for Android devices, or a MAC Address for other devices.

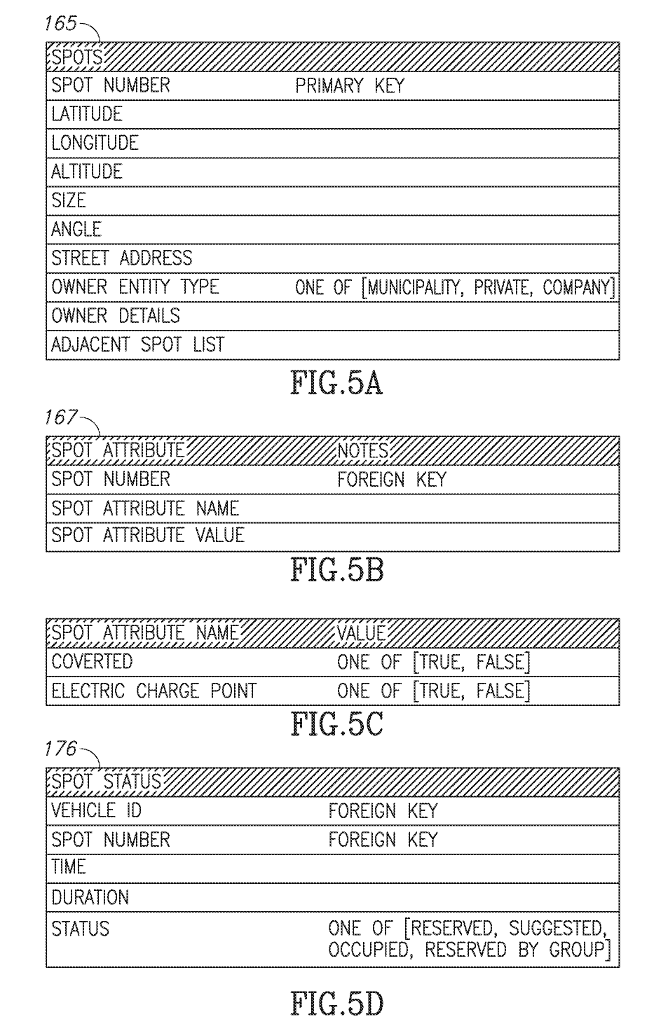

Reference is now made to FIGS. 5A and 5B, which illustrate a spot table 165 and a spot attribute table 167, together forming spot database 164, and to FIG. 5C, which is an exemplary listing of possible spot attributes, useful in understanding spot attribute table 167. Spot table 165 may comprise one record per spot, where each record may comprise multiple facts about the spot, such as its spot number, its location (defined by latitude, longitude, altitude (generally related to a level in a parking garage), and street address), its size, its angle to the curb, its owner entity type (such as municipality, private or company), and its owner's details.

Spot attribute table 167 may comprise multiple records per spot, where each record may comprise a spot number as a foreign key, an attribute and a value of the attribute. There may be multiple attributes per spot and there may be multiple types of attributes. FIG. 5C lists a few exemplary attributes, such as whether or not the spot is covered or if it has an electric charging facility. Other attributes might be whether it is underground, not easily accessible, partly on the sidewalk.

Reference is now briefly made to FIG. 5D, which illustrates a spot status table 176 forming part of spot database 164. Spot status table 176 may store all the spots which may be unavailable in some way (whether occupied or to be occupied in the future) and may comprise multiple records per spot status. Each record may store the status (such as reserved, suggested, occupied or ReservedByGroup, as described in more detail hereinbelow) the vehicle ID and spot number as foreign keys, as well as a time and, optionally, an expected duration, of the status. Thus, there may be multiple records per spot.

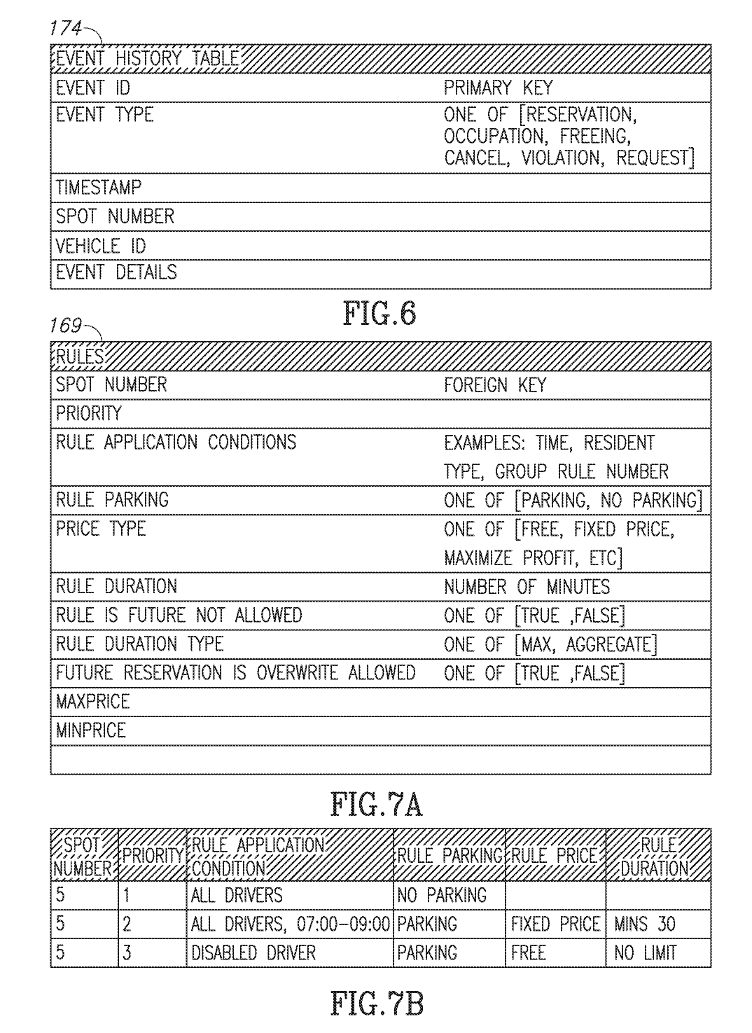

Reference is now briefly made to FIG. 6, which illustrates an event history table 174, forming part of event history database 168. Event history table 174 may comprise one record per event and may store an event ID, an event type (such as reservation, occupation, freeing, cancel, violation, request, etc.), a timestamp, vehicle ID and spot number and any event details. The request event may store the original request and/or the destination.

Reference is now made to FIGS. 7A and 7B, which illustrate a rules table 169, forming part of rule database 166, and an exemplary set of rules, useful in understanding rules table 169. Rules table 169 may comprise multiple records per spot, where each record may comprise a spot number as a foreign key, a rule priority value for the rule, an application condition for the rule, and a parking scheme comprising a parking result for the rule, a price for the rule and a duration for the rule. The record may also contain multiple flags, such as FutureNotAllowed, DurationType and FutureReservationlsOverwriteAllowed. DurationType may be either maximum or aggregate, meaning that the duration of this rule may have a limit or may be added to other durations, as described in more detail hereinbelow. Typically, there may be multiple rules per spot.

Application conditions define when the rule applies. The conditions may be defined by time, by resident type, by group rule number (described in more detail hereinbelow), or by any other suitable condition. The parking result may be the result of the rule—is parking allowed or not? Rule price type may define the algorithm to generate the price, which may be any algorithm which may generate a price. Rule duration may set limits on how long a driver may park. MinPrice and MaxPrice may define the minimum and maximum price allowable for the spot.

FIG. 7B illustrates the rules for spot 5 with an exemplary table of the records in rules table 169. There are 6 columns, for spot number, rule priority, application condition, parking result, pricing and duration. In FIG. 7B, there are three rules for spot 5. The first rule might be applied to all drivers 12 with a result of no parking. In other words, no driver may park in spot 5. The second rule might be that that parking is allowed from 7-9 am for all drivers for a fixed price, but only for 30 min. The third rule might be that disabled owners may park for free for any length of time.

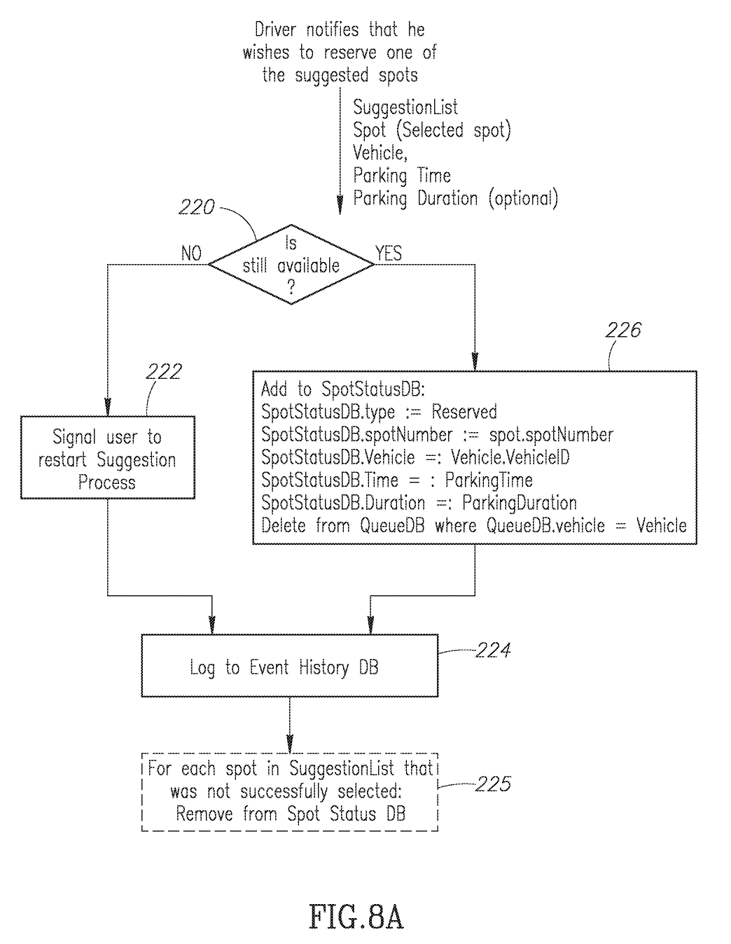

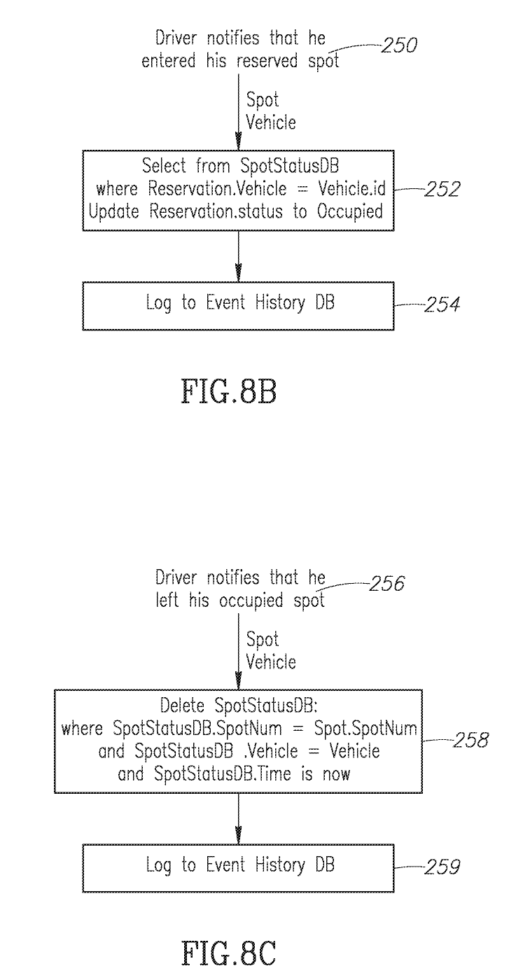

As shown in FIG. 8A, to which reference is now made, parking event and reservation manager 120 may receive (step 220) a driver's spot selection, parking time and expected parking duration, the vehicle ID and the original suggestion list given to the driver and may check that the spot is still available (i.e. hasn't been reserved by anyone else in the meantime). If it is no longer available, manager 120 may notify (step 222) the user of the failure as well as restarting the suggestion process, described in more detail hereinbelow and may log (step 224) the failure in event history database 168.

If the spot is still available, then manager 120 may update (step 226) the record in spot status table 176 for the selected spot with the vehicle number, parking time and duration and may change the status, for example, to that of CurrentReserved, for a current reservation, and to FutureReserved, for a future reservation.. In step 226, the reserved spot may be deleted from queue database 172, if it was in the queue, as described in more detail hereinbelow. For each spot in SuggestionList1 that was not successfully selected, remove (step 225) it from spot status table. Manager 120 may then log (step 224) the event in event history database 168.

As shown in FIG. 8B, to which reference is now briefly made, parking event and reservation manager 120 may receive (step 250) a driver's notification that s/he has parked and, in step 252, may change the status record in spot status table 176 for the selected spot to that of Occupied. Parking event and reservation manager 120 may also log (step 254) the parking event in event history database 168.

As shown in FIG. 8C, to which reference is now briefly made, parking event and reservation manager 120 may receive (step 256) a driver's leaving notification and, in step 258, may delete the spot status record from spot status table 176 for the indicated spot and the indicated vehicle. Parking event and reservation manager 120 may also log (step 259) the leaving event in event history database 168.

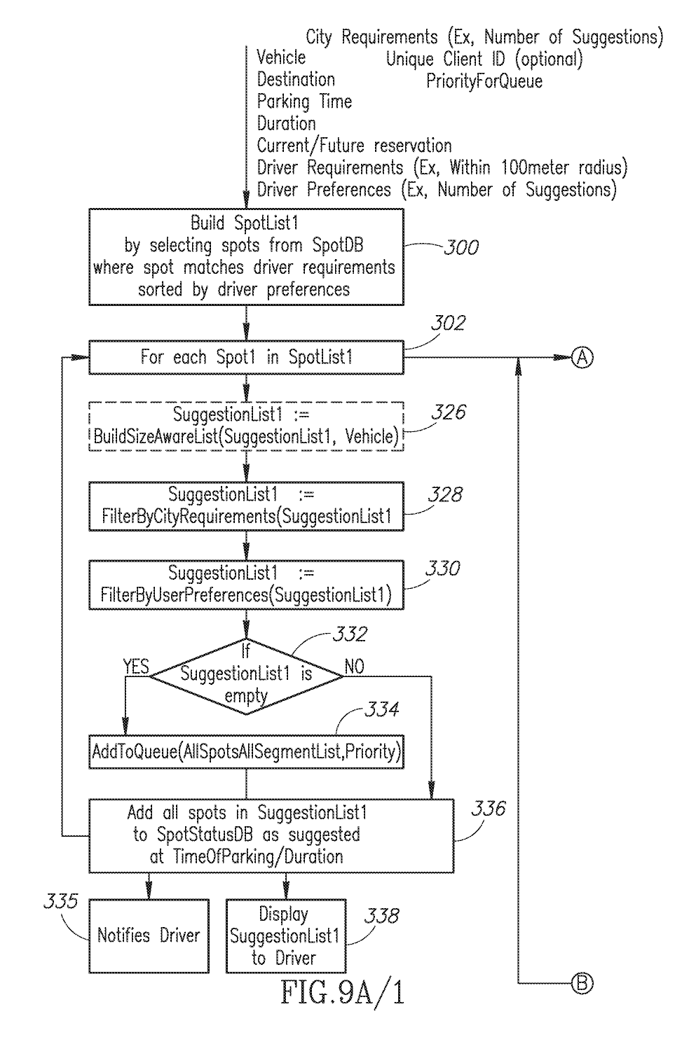

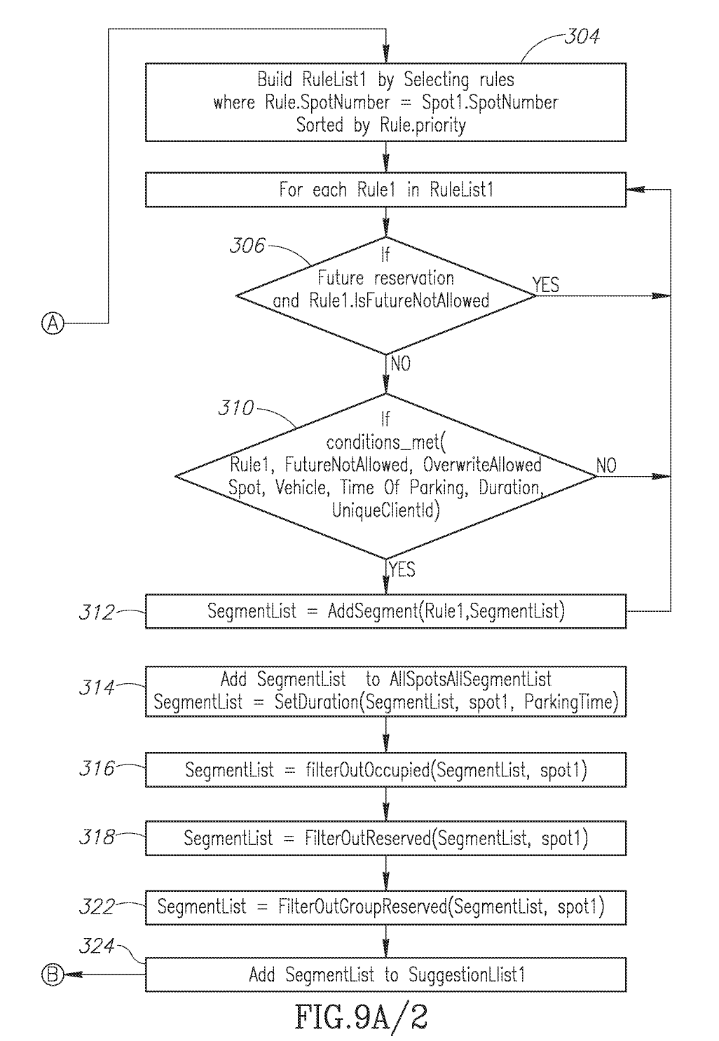

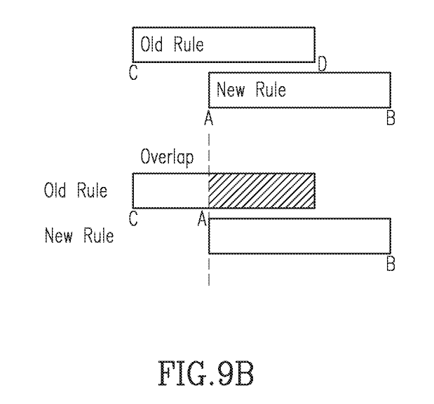

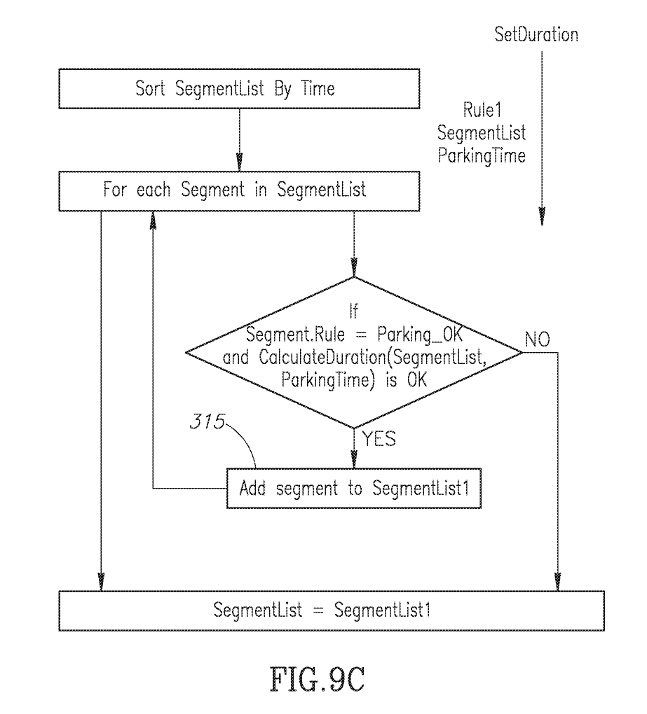

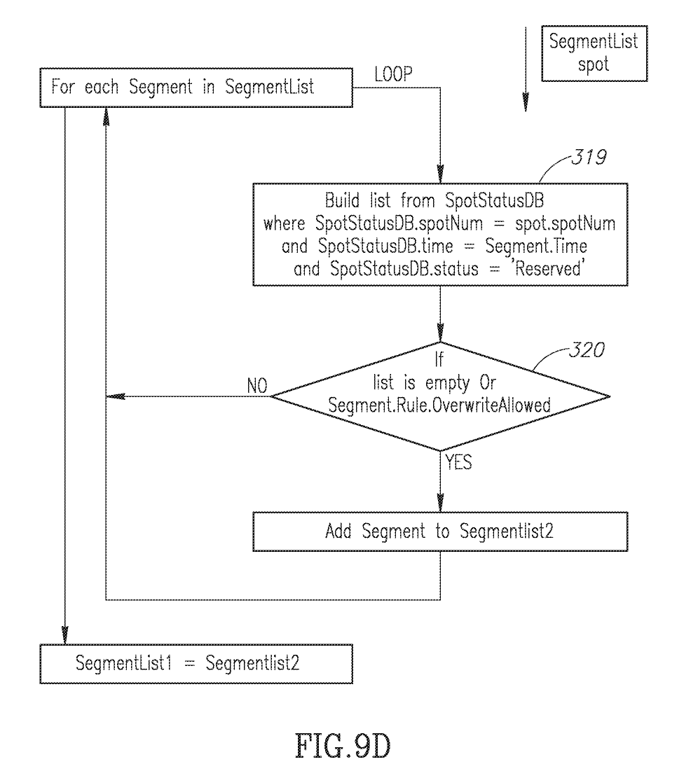

Reference is now made to FIG. 9A, which illustrates the operation of suggestion list builder 110 using vehicle database 162, spot database 164 and rule database 166 upon receiving at least the destination information and vehicle license plate number. Other input may be the desired duration, the desired parking period (now or in the future), driver requirements (such as within a given walking distance of the destination), other driver preferences (such as the number of suggestions N to provide), any city preferences (such as the number N of suggestions to provide) and optionally, the unique client ID and/or a priority for a queue, if no spot may be found. Reference is also made to FIG. 9B, which is helpful in understanding the operation of suggestion list builder 110 and to FIGS. 9C and 9D, which illustrate methods forming part of the operation of FIG. 9A.

In step 300, suggestion list builder 110 may build a SPOTLIST1, a list of all spots in spot table 165 which are currently available and which meet any driver requirements (such as within a given walking distance) and sorted by any driver preference(s) given by driver 12. The driver's preferences may be checked against the spot information and attributes in spot table 165 and spot attribute table 167.

A driver preference may be any attribute a spot may have, such as covered, or having an electric charging facility, or only free parking, or owned by a particular owner, etc. Suggestion list builder 110 may use any suitable mapping software or service, such as Google™ Maps™, that may determine a distance between two locations and may provide such software with the driver's requirements and a request for all locations within those requirements. Suggestion list builder 110 may then review the location information of the spots in spots table 165, selecting only those whose locations match the list received from the mapping software and sorting the list according to the driver preferences received as input.

In step 302, a loop is started over the spots in SPOTLIST1. First, in step 304, the rules for the current spot are pulled from rules table 169, into a RULELIST1, and are ordered according to their rule priority value.

In step 306, if there are any future reservations for the current spot and the rule has the FutureNotAllowed flag active, then the rule is skipped.

Otherwise, the condition for each rule is checked, in step 310. Since the conditions may refer to any attribute of a vehicle, a spot, a driver, or parking requirements, the vehicle, spot and UniqueID information, as well as the time of parking and duration, FutureNotAllowed and OverwriteAllowed flags are provided to step 310. For each rule, if the condition is met, then the parking result, price and duration of the rule are added (step 312) into a parking segment list SegmentList.

FIG. 9B shows how segments are added together. The time and duration of a new rule, marked from A to B, is compared to the time and duration of the current rule, marked from C to D, in SegmentList, known as SegmentTime. Suggestion list builder 110 trims the time and duration of the current segment so that it doesn't overlap with the new rule and adds the new rule to the segment. In effect, the new rule overrides the current segment for its time period. However, if the current segment has time outside of the time of the new rule, that outside time remains. The result is an aggregation of rules which are active at different times. In the example of FIG. 9B, the result is a rule where the old rule is active from C to A and the new rule is active from A to B. If two rules are active for the same period, the new rule will replace the old rule.

For the example in FIG. 7B, if the request is for a vehicle which has a disabled owner and the requested parking time is 10 am-12 pm, SegmentList will have the following values as suggestion list builder 110 moves through the rules for spot 5:
a. Rule 1: condition is ALL, which applies, so rule 1 is added to SegmentList for all time
b. Rule 2: condition is not met (it is not 7 am-9 am), so the rule is not added to SegmentList
c. Rule 3: condition is DISABLED, which applies, so rule 3 replaces rule 1 in SegmentList for all time

Returning to FIG. 9A, once the loop on the rules for the spot finishes, in step 314, suggestion list builder 110 may initially store the initial segment list in AllSpotsAllSegmentList and then may set the duration of the parking for that spot by reviewing the segments in SegmentList. As shown in FIG. 9C, to which reference is now briefly made, suggestion list builder 110 may sort SegmentList by time and for each segment, may add (step 315) the segment to a SegmentList1 if the parking result for the segment is Parking and the parking time is within the parking duration. When the process has finished for all segments, suggestion list builder 110 may update SegmentList with the temporary list SegmentList1.

In step 316, suggestion list builder 110 may check if the spot is Occupied and may return a Null if it is. Otherwise, the SegmentList is unchanged.

In step 318, suggestion list builder 110 may check (step 319, FIG. 9D) if the spot is Reserved for any of its segments. Since system 100 may enable the city to override a driver's reservation, suggestion list builder 110 may check (step 320) if the OverwriteAllowed flag is active for this spot, for each segment in SegmentList. The segment remains only if the spot is not reserved or if overwriting is allowed.

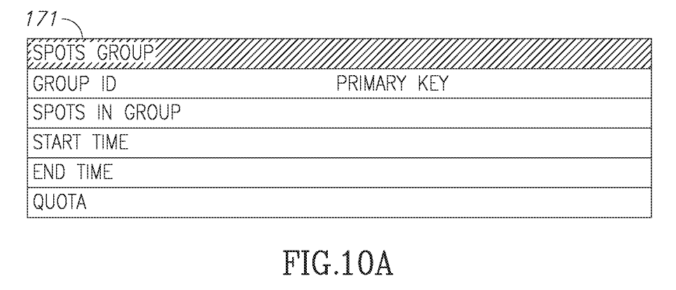

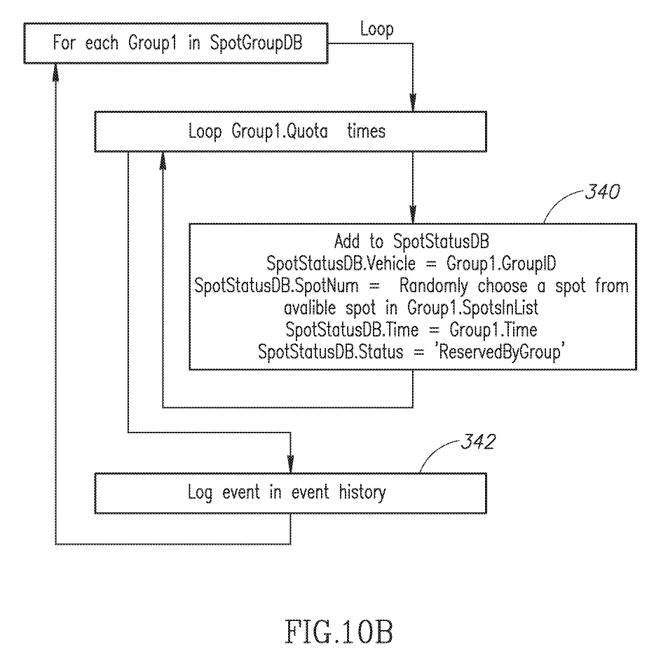

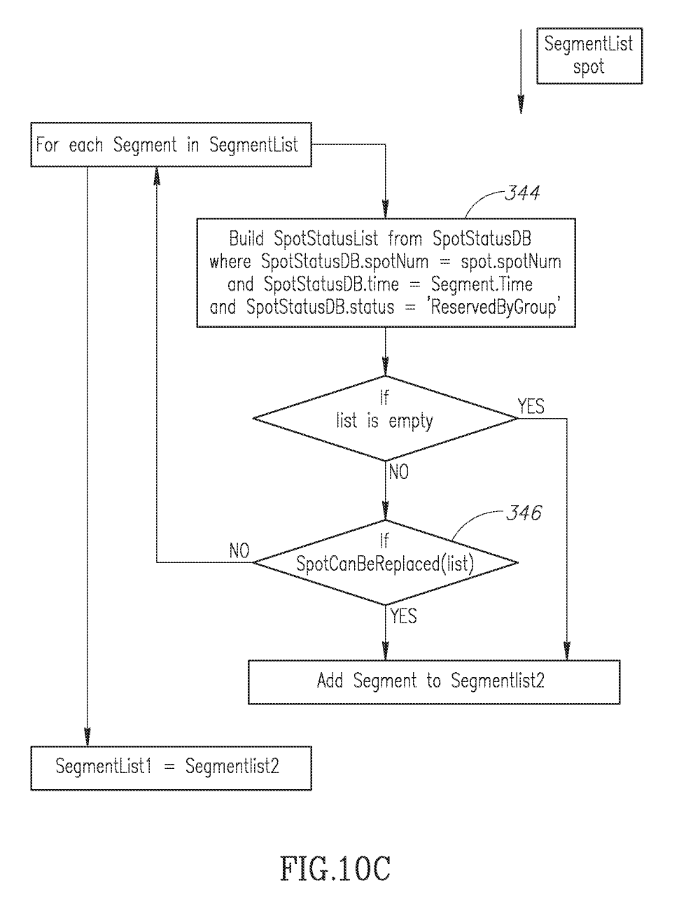

In step 322 (of FIG. 9A), suggestion list builder 110 may handle group reservations, described in more detail hereinbelow with respect to FIGS. 10A and 10B, updating SegmentList as a result.

In step 324, suggestion list builder 110 may add the updated SegmentList to a SuggestionList1.

In an alternative embodiment of the present invention, each spot may be of a small size, smaller than that of a “standard” vehicle. SuggestionList may then provide multiple groups of neighboring spots, rather than a single spot. This alternative embodiment is implemented in step 326 where builder 110 may optionally provide SuggestionList1 to a BuildSizeAwareList function, whose process is described in the patent application filed concurrently herewith and entitled “Parking Space Management System and Method” attorney docket number P-14273-US, assigned to the common assignee of the present application, which application is incorporated herein by reference.

In step 328, manager 120 may filter the resultant suggestion list by any city requirements, such as the number of suggested spots to provide. In step 330, manager 120 may filter the updated suggestion list by any driver preferences, such as having an electric charging facility. Once the suggestion list is filtered by all of the various preferences, in step 332, manager 120 may check if the final suggestion list is empty. If it is, then suggestion list manager 120 may add (step 334) all of the spots in the original segment list AllSpotsAllSegmentList, with their priority levels, to queue database 172.

Otherwise, suggestion list builder 110 may update (step 336) the statuses of the spots listed therein as being Suggested, with the listed time and duration of parking.

Finally, in step 338, parking event and reservation manager 120 may display the remaining spots in the suggestion list to the driver, typically ordered according to which spot is closest to the destination, as received from the mapping software.

It will be appreciated that the order of filtering and sorting according to preferences and other requirements are exemplary only and may be different for different systems and/or different regional authorities.

Reference is now made to FIG. 10A, which illustrates a spot group table 171, forming part of spot database 164. Spot group table 171 may store groups of parking spots, such as a street, a neighborhood, a parking lot, or just any group of spots, which may have a group reservation. For example, a group reservation might be: 10% of the spots in the group have to be reserved for residents. This kind of group reservation may be more efficient for parking than the current system of reserving X fixed spots for residential parking.

Each record in spot group table 171 may list the group ID, a list of the spot numbers forming the group, a start and end time for the group reservation and a “quota” defining the number of spots in the group which must remain reserved for members of the group. For the example above, there may be 100 spots in the group, so the quota of 10%, may be set to 10 spots.

Reference is now made to FIG. 10B, which illustrates a method for initializing a group reservation and to FIG. 10C, which illustrates a method for handling a group reservation, implemented at step 322 of FIG. 9A. Initially, suggestion list builder 110 randomly sets (step 340) X spots of each group to the ReservedByGroup status, where X is defined by the Quota variable, and stores the status of these spots in spot status table 176. Suggestion list builder 110 then logs (step 342) this event in event database 168.

The initial ReservedByGroup spots may be suggested for a member vehicle of the group. Alternatively, if one of these spots appears on a suggestion list for a non-member vehicle, suggestion list builder 110 may determine if the reserved spot may be replaced with a different spot in the group, thereby freeing the previously reserved spot to be given to a non-member. In FIG. 10C, suggestion list builder 110 may review each segment in the current segment list and may build (step 344) a spot status list of all spots in the segment which are ReservedByGroup for that segment time. Suggestion list builder 110 may then check (step 346) to see if the spot can be replaced by a second spot (i.e. if there are any other spots in the group that are available during the relevant time period). If it can, then the segment is maintained, with the new spot. If the second spot also belongs to a group, then suggestion list builder 110 may also try to replace the second spot, recursively.

It will be appreciated that any rule may be implemented and it may be conditioned on any attribute that may be stored in system 100, whether it be a vehicle attribute or a spot attribute. This may provide considerable flexibility to system 100 to accommodate all types of vehicles and all types of spots, as well as all types of requirements/preferences that drivers 12 may have.

For example, a lot may be divided into truck spots, bus spots and private car spots. Since vehicle size may be a vehicle attribute and spot size may be a spot attribute, a rule may be written that a particular spot or group of spots may only be for vehicles of a specific size.

Alternatively, a driver preference may be to park in lots owned by a particular company. This preference may be implemented in step 300 when selecting the initial spots in SPOTLIST1 or at any other appropriate step.

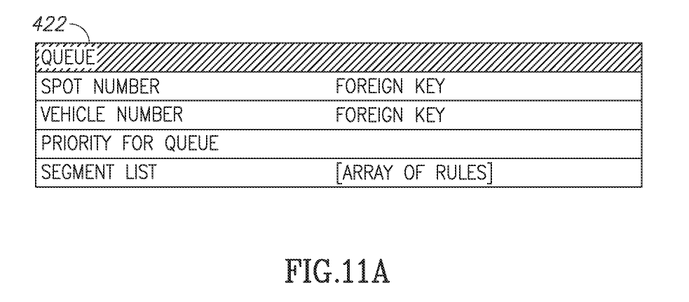

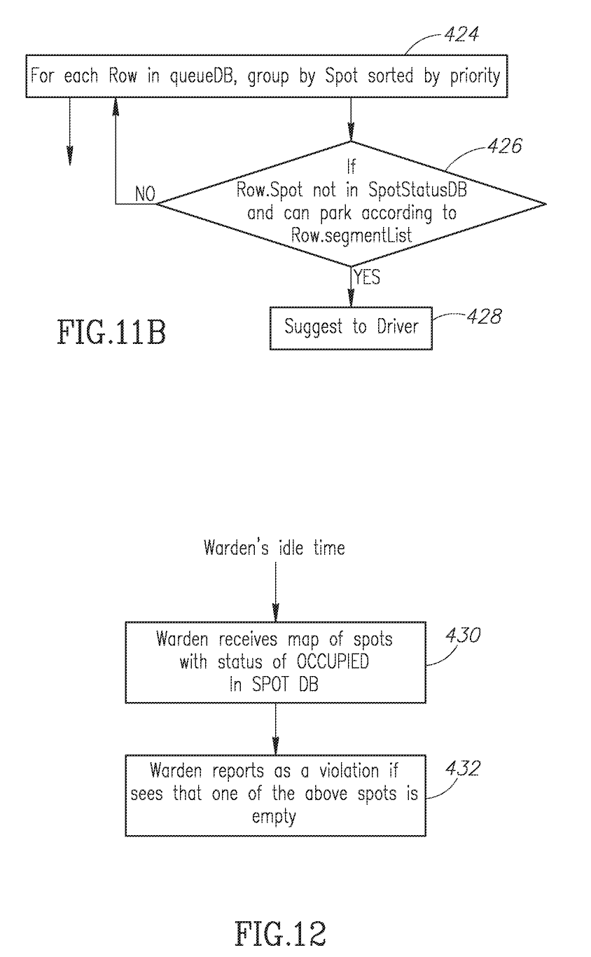

Reference is now made to FIGS. 11A and 11B, which illustrate a queue table 422 and a periodic process for parking event and reservation manager 120 to implement to review queued requests, respectively. Queue table 422 may store a spot number, a vehicle number, a PriorityForQueue value and the segment list generated from the original request. PriorityForQueue may be a priority level for the initial request, which may be any suitable priority level, such as a priority level based on location in the queue or may be a priority level also based on the reputation of driver 12 and/or the of the vehicle.

As shown in FIG. 11B, parking event and reservation manager 120 may periodically review in queue database 172 in order to provide a suggestion to driver 12. Manager 120 may initially group (step 424) the spots and then sort them according to the priority PriorityForQueue. For each spot, manager 120 may check if the spot is currently available and if it is available for parking according to the rules in SegmentList. If it is, manager 120 may then offer (step 428) the spot to driver 12.

Reference is now made to FIG. 12, which illustrates an operation of violation system 130 for warden 14. Because drivers 12 report violations to violation system 130, wardens 14 do not need to check for most violations and the system thus becomes substantially self-regulating. Wardens may be useful in helping drivers with difficulties, such as obtaining new spots if their reserved spots are occupied or to help them access the system if they don't have a cellphone. In this context it should be stressed that, as stated above, the system may be accessed by phone call or SMS (text message), so that while access via a smartphone is an advantage, the present invention provides a so-called 360° solution, namely, anyone, whether in possession of a 2G, 3G or 4G mobile phone, or even in possession of no mobile phone whatsoever, can access the system.

In addition, wardens 14 may have a handheld device (not shown) to indicate to violation system 130 which spots he sees that are currently open. This may help system 100 identify vacant/available spots whose previous occupant failed to report departure to the system, leaving the system unable to utilize the spot. Violation system 130 may provide (step 430) each warden 14 with a map of the occupied spots, including at least one visible attribute of the parked vehicles, and may request him or her to indicate (step 432) which of the spots are empty.

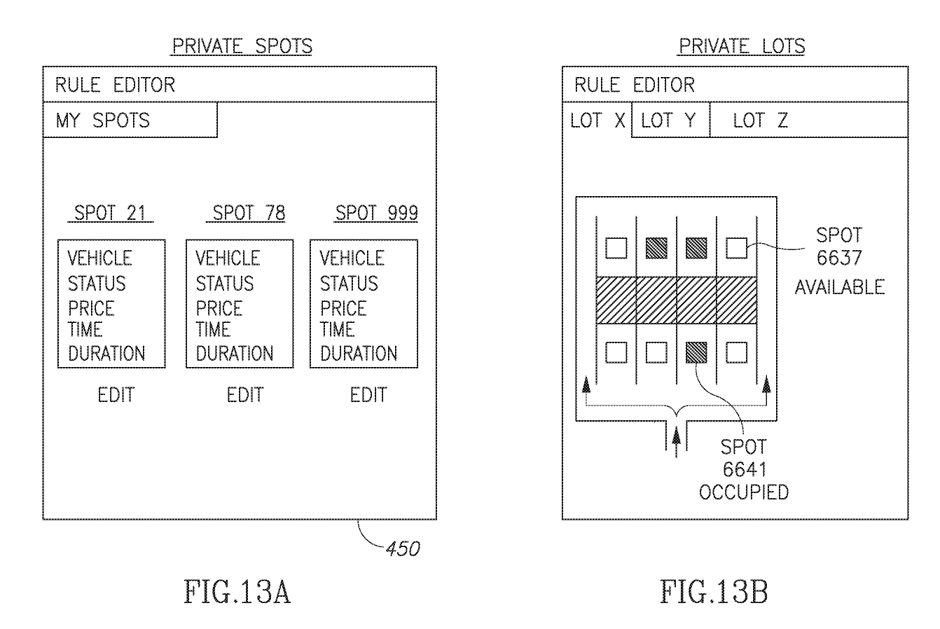

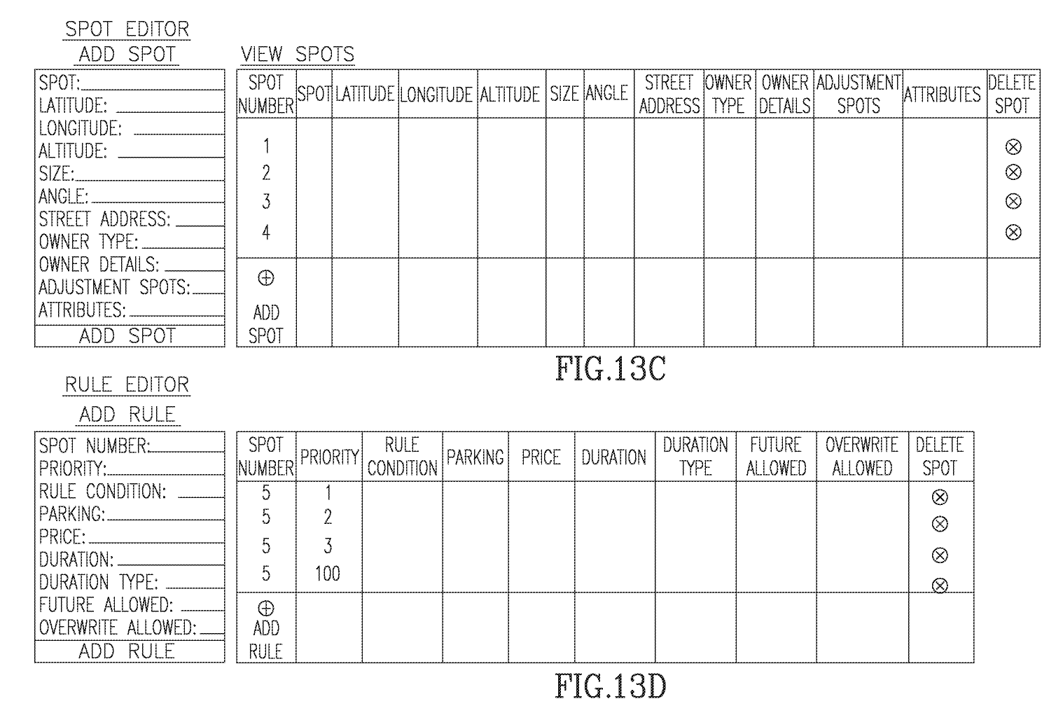

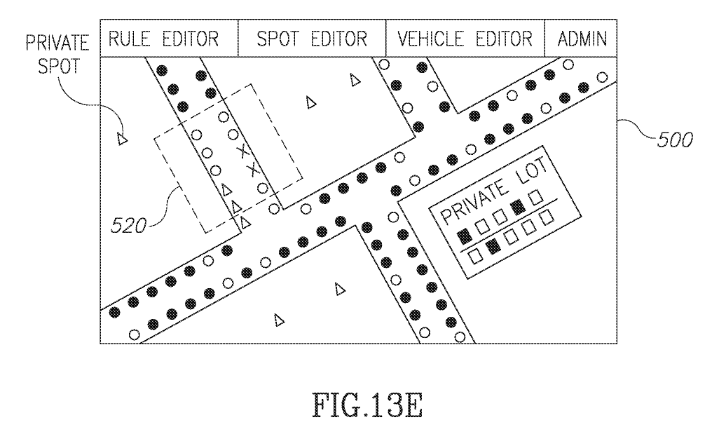

Reference is now made to FIGS. 13A and 13B, which are exemplary screenshots for private spot manager 152 and lot spot manager 153, respectively, and to FIGS. 13C and 13D, which illustrates a spot editor and a rules editor, respectively, that they might use. Managers 151, 152 and 153 may be cloud-based and may be accessible to owners and city employees at any time.

As shown in screen 450, private spot manager 152 may enable a private spot owner to enter his own details, such as name, address, and, optionally, bank account information. In screen 450, private spot manager 152 may receive details and/or attributes about each spot the private spot owner has, such as the size of the vehicle that can be accommodated, price, hours when it is available (listed as “Time”), duration and its current status.

A private lot owner, on the other hand, may have multiple spots, all of which may have the same set of rules. Therefore, the screen for a private lot, shown in FIG. 13B, has a map of the shape of the lot and a labeling of where each spot is.

FIG. 13C shows an exemplary spot editor 504, which may have separate fields for spot number, latitude, longitude, altitude, size, angle, street address, owner type, owner details, adjacent spots and attributes. The attribute field may provide a selector to select among the attributes currently allowable in the system. FIG. 13C also shows a table view of the spots which an owner may utilize to view all of his/her spots.

FIG. 13D shows an exemplary rules editor 502, which may have separate fields for spot number, priority, rule condition, parking result, parking duration, price, duration type, future allowed and, for city managers, overwrite allowed. Some of these fields may enable the owners to select among a set of allowed choices, while others may be sliders. In addition, FIG. 13D also shows a table view of the rules which an owner may utilize to view the set of rules for a spot or a group of spots.

FIG. 13E, to which reference is now made, illustrates city control center 151, which may comprise a map 500 of the spots in the city. When a city employee clicks upon a spot on map 500, spot editor 504 may appear, showing the spot number, its coordinates, such as latitude, longitude, altitude, its physical properties, such as size, angle, street address, ownership, and any other attributes, such as covered or electric charging facility. Spot editor 504 may include the ability to activate or delete the spot.

Clicking upon the spot may also bring up rule editor 502 which may list the current rules governing the spot and may enable the city employee to add a new rule.

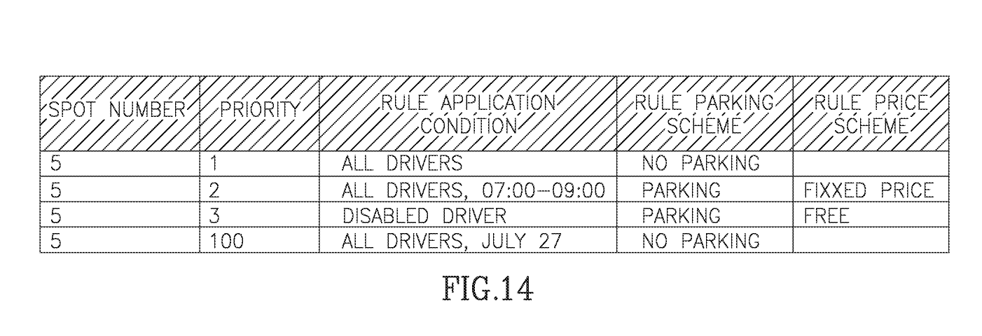

In addition, a city employee may mark a region 520 on map 500 and may utilize rule editor 502 to provide a new rule for all spots in region 520. This may make it easy to add a large plot of spots into the system. It may also make it easy to change rules across the city, as the city's needs change. Moreover, it may enable city employees to add a temporary city “override” in the form of a new rule to be added to a group of spots. This is shown in FIG. 14, to which reference is now made. FIG. 14 shows the rules of FIG. 7B with a city override rule, such that spot #5 is not available for parking at all, for example, on July 27^{th}, due to a city override. Rule editor 502 may select the priority level to be higher than all the other rules in the group, to ensure that the override has highest priority. It may also add an OverwriteAllowed flag to spot #5 for the date in order to cancel all future reservations for the time period listed in the condition and may so notify the affected drivers. In this example, the city override priority is set to 100.

Regional authorities can write rules which override rules of other owners. To do so, system 100 may give different levels of priority to the different owners.

In addition, if an owner or regional authority wants to change just one element of a rule, the remaining fields may be left with Null values.

System 100 may also comprise a vehicle group table which may create groups of vehicles to which attributes may be applied at one time. This may be of particular use for parking lot operators which may have a plurality of spots with similar attributes. This may also be useful for assigning rules to a group of vehicles.

It will be appreciated that the present invention may provide flexibility to city managers and regional authorities by providing multiple attributes to parking spots, vehicles and drivers, thereby to enable easy matching among them and to accommodate the many preferences drivers may have. The system is highly editable, enabling changes to occur over time.

The system may be extended in many ways. For example, since the color of the vehicle is stored in vehicle database 162, a map may be provided to driver 12 to show him/her the way back to his/her car, and the map may show the colors of the cars parked near to the driver's parking spot.

A driver may be redirected to an alternate location better fitting his needs (e.g. when a driver requests a parking spot near a mall, and receives a suggestion to shop in another mall with better parking possibilities).

System 100 may remind driver 14 to move his/her car, before his/her time to park there is up. Alternatively, it may offer the ability to pay more for leaving the car in an expired parking cell or the ability to receive an extension of time.

System 100 may receive driver notifications from drivers 12 themselves or from any other parking sensor and/or from a driver's GPS system or other navigation system which may sense when driving has stopped.

System 100 may also comprise a statistical analyzer, which may be part of city control center 151, which may review the data stored in event database 168 and may provide at least one of the following statistics: waiting time for spot suggestions, number of spots currently available, expected costs of parking and demand at a given time, etc.

City control center 151 may provide the current parking status for all spots in the city, determinations of supply and demand for parking and statistical analysis of past parking behavior.

In a preferred embodiment, especially when the system is applied to a region such as a municipality which is transitioning from a current or default status in which parking rules applying to municipal controlled parking by use of signs or painted markings, such as those indicating no parking, restricted parking, or invalid parking, for example, system 100 of the present invention may be viewed as an override system. In other words, as long as the various communications networks inherent in system 100 are in working order, then the only way to legally park in the city is through the system 100 and the rules implemented thereby. However, in case of a failure of system 100, such as by failure or downfall of the communications networks, at least in part, the city has default settings, whose rues are available to all users.

In one example, the rules simply revert to the previous state prior to the transition, as indicated by the signs and painted markings, for example. Alternatively or in addition, system 100 may also comprise a backup database storing the city's “default” settings for each parking spot in a downfall situation, which may be downloaded to a driver's smartphone, for example, during installation, and for use offline. Alternatively or in addition printed maps of the city's “default” settings may be posted on billboards, or in the printed or electronic media, and the like.

It will be appreciated that system 100 may provide control over previously un-monitored parking spots, such as free parking. System 100 may incorporate the un-monitored parking spots so as to become managed by the parking system and thus may increase the number of managed parking spots in the region. This is done in a manner similar to that shown and described above and includes mapping the un-monitored parking spots; assigning an identifier to each of them; evaluating selected details and attributes of each newly mapped spot and adding these details and attributes to spot database 164, thereby increasing the number of managed parking spots.

It will further be appreciated that the present invention may provide control of parking in private lots to municipal authorities, rather than to parking lot owners as in the case of prior art parking systems. It may also reduce pollution in the region by reducing the amount of traveling a driver may have to do to arrive at a parking spot. This may be of particular importance for venues with poor ventilation, such as large parking garages.

Moreover, system 100 may receive information regarding traffic patterns in a vicinity of the destination in order to minimize the slowing effect of the vehicle on the traffic in the vicinity of the destination. This may minimize air pollution not only from the vehicle seeking to park, but also by traffic in the vicinity of the destination.

Moreover, system 100 may receive information regarding traffic patterns in a vicinity of the destination in order to minimize the slowing effect of the vehicle on the traffic in the vicinity of the destination. This may minimize air pollution from the vehicle.

It will also be appreciated that system 100 may be operative with parking spots which are not visibly marked. For example, navigation system 170 may direct driver 12 directly to a parking spot, as defined by the latitude, longitude and optional, altitude, with no need for driver 12 to find the markings on the pavement.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a computer, computing system, client/server system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. Such a computer program may be stored in a computer readable storage medium, such as, but not limited to, any type of disk, including floppy disks, optical disks, magnetic-optical disks, read-only memories (ROMs), compact disc read-only memories (CD-ROMs), random access memories (RAMs), electrically programmable read-only memories (EPROMs), electrically erasable and programmable read only memories (EEPROMs), magnetic or optical cards, Flash memory, or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A parking system, the system comprising:
a. a vehicle database of vehicle data including at least one vehicle attribute;
b. a spot database storing details and attributes of parking spots in a pool of parking spots of a regional authority, said pool comprising at least on-street parking spots and off-street parking spots, and said details comprising at least a parking space identifier and at least one attribute of a type corresponding to said at least one vehicle attribute of said vehicle data, said spot database enabling editing of at least said spot details and attributes by owners and of spot parking schemes of groups of spots by the regional authority, where said owners comprise at least said regional authority and at least one of: lot owners and private owners of individual spots;
c. a parking event and reservation handler for
(i) at least receiving parking requests which comprise for a specified vehicle at least a destination,
(ii) determining a set of parking spots from said pool which are available within a vicinity of a destination of a driver and which match said at least one attribute of said vehicle,
(iii) providing the set of parking spots to said driver for his selection and
(iv) reserving a selection by said driver of one of said set of parking spots for said driver;
and
d. a violation system in communication with a city violation system for receiving violation reports at least from drivers reporting that said reserved parking spot is occupied.

2. In a region having a plurality of vehicle parking spots having default rules conditioning their use by vehicle drivers, a method of managing parking within the region, said method including:
A. selectably overriding at least some of the default rules including:
having a pool of parking spots in a region having default rules conditioning their use by vehicle drivers, the rules being operated by a regional authority and said pool including separately owned parking spots that are owned by owners other than the regional authority, including maintaining a spot database storing details and attributes of at least on-street parking spots and off-street parking spots, said details comprising at least a physical attribute of said parking spot and an identifier;
for each parking space, storing ownership information and a set of parking rules having conditions for application of said parking rules, wherein a portion of said parking rules are defined by an owner of said parking space;
enabling the regional authority to add other parking rules to a group of said separately owned parking spots;
receiving parking requests which comprise for a specified vehicle at least a destination,
determining a set of parking spots from said pool which are available within the vicinity of a destination of a driver and whose spot details match at least one attribute of a vehicle of said driver stored in a vehicle database;
maintaining an editable rule database storing current rules defining current conditions for use of said parking spots;
receiving parking requests from drivers of the vehicles and applying said current rules in handling said requests, each request comprising, for a specified vehicle, at least a destination and at least one driver preference;
determining, irrespective of the ownership of said parking spots, a set of parking spots from said pool which are currently available within a vicinity of a destination of a driver and which are suitable for said vehicle and match said at least one driver preference;
receiving and reserving a selection by said driver of one of said set of parking spots for said driver; and
using at least one communications network for communicating data among the vehicle database, the spot database, the rule database, the parking event and reservation handler and the drivers so as to receive and process said requests; and
B. in the event of failure of at least a portion of the at least one communication network, cancelling said current rules and applying said default rules.

3. A parking system, the system comprising:
a vehicle database of vehicle data including at least one vehicle attribute;
a spot database storing details and attributes of parking spots in a pool of parking spots in a region, said details comprising at least a parking space identifier and at least one attribute of a type corresponding to said at last one vehicle attribute of said vehicle data;
a parking event and reservation handler
for at least receiving parking requests which comprise for a specified vehicle at least a destination,
for determining a set of parking spots from said pool which are available within a vicinity of a destination of a driver and which match said at least one attribute of said vehicle, and
for reserving a selection by said driver of one of said set of parking spots for said driver.

4. A method of parking comprising:
having a pool of parking spots in a region, said pool comprising at least on-street parking spots and off-street parking spots;
receiving parking requests which comprise for a specified vehicle at least a destination,
determining a set of parking spots from said pool which are available within the vicinity of a destination of a driver and whose spot details match at least one attribute of a vehicle of said driver stored in a vehicle database;
providing the set of parking spots to said driver for his selection; and
reserving a selected parking spot for said driver.

5. A parking system, the system comprising:
a vehicle database storing vehicle data from a vehicle registry;
a spot database storing details and attributes of parking spots in a pool of parking spots, said details comprising at least a physical attribute of said parking spot and an identifier;
a rule database storing rules defining the conditions for use of said parking spots; and
a parking event and reservation handler for:
at least receiving parking requests comprising, for a specified vehicle at least a destination,
for determining a set of parking spots from said pool which are available within a vicinity of a destination of a driver and which are suitable for said vehicle, and
for reserving a selection by said driver of one of said set of parking spots for said driver.

6. A parking system according to claim 5, wherein said parking requests also include a least one driver preference, and said determined parking spots also match said at least one driver preference.

7. A regional parking system comprising:
a spot system for at least storing details and attributes of parking spots in a pool of parking spots of a regional authority, said details comprising at least a parking spot identifier;
a parking event and reservation manager at least
for receiving a destination of a driver,
for determining a set of parking spots from said pool which are available within the vicinity of said destination and whose spot details match at least one detail of a vehicle of said driver stored in a vehicle database, and
for reserving a selection by said driver of one of said set of parking spots; and
a violation system in communication with a city violation system for receiving violation reports at least from drivers reporting that said reserved parking spot is occupied.

8. A regional parking system according to claim 7, wherein said violation system is also operative to update a reputation indication of said driver upon receipt of a violation authorization from a city warden.

9. A method of reducing vehicle-related crime comprising:
having a pool of parking spots in a region;
receiving a parking request from a driver which comprise for a specified vehicle at least a destination,
determining a set of parking spots from said pool which are available within the vicinity of a destination of a driver and whose spot details match at least one attribute of a vehicle of said driver stored in a vehicle database;
providing the set of parking spots to said driver for his selection;
making a reservation of a selected parking spot for said driver; and
providing details of said reservation to a law enforcement agency.

10. In a region having a plurality of vehicle parking spots having default rules conditioning their use by vehicle drivers, a method for selectably overriding at least some of the default rules, said method including:
having a vehicle database storing vehicle data from a vehicle registry;
maintaining a spot database storing details and attributes of parking spots in a pool of parking spots in the region, said details comprising at least a physical attribute of said parking spot and an identifier;
maintaining an editable rule database storing current rules defining current conditions for use of said parking spots;
maintaining a parking event and reservation handler at least to receive parking requests from drivers of the vehicles and for applying said current rules in handling said requests,
each request comprising, for a specified vehicle, at least a destination and at least one driver preference, to determine a set of parking spots from said pool which are currently available within a vicinity of a destination of a driver and which are suitable for said vehicle and match said at least one driver preference, and to make a reservation of a selection by said driver of one of said set of parking spots for said driver;
using at least one communications network for communicating data among the vehicle database, the spot database, the rule database, the parking event and reservation handler and the drivers so as to receive and process said requests; and
in the event of failure of at least a portion of the at least one communication network, cancelling said current rules and applying said default rules.

11. A regional parking system comprising:
a spot system for at least storing details and attributes of parking spots in a pool of parking spots of a regional authority, said details comprising at least a parking spot identifier, and for enabling editing of at least said spot details and attributes by owners and of spot parking schemes of groups of spots by the regional authority, where said owners comprise at least said regional authority and at least one of: lot owners and private owners of individual spots;
a parking event and reservation manager at least
for receiving a destination of a driver,
for determining a set of parking spots from said pool which are available within the vicinity of said destination and whose spot details match at least one detail of a vehicle of said driver stored in a vehicle database, and
for reserving a selection by said driver of one of said set of parking spots.

12. A method of parking comprising:
having an identifier associated with each of a plurality of parking spots in a pool of parking spots in a region whose parking rules are operated by a regional authority, said pool including separately owned parking spots that are owned by owners other than the regional authority;
for each parking space, storing ownership information and a set of parking rules having conditions for application of said parking rules, wherein a portion of said parking rules are defined by an owner of said parking space;
enabling the regional authority to add other parking rules to a group of said separately owned parking spots; and
determining a set of parking spots from said pool which are available, which are within a vicinity of a destination of a driver and whose conditions apply, irrespective of the ownership of said parking spots.

13. In a region having a pool of parking spots managed by a parking system and previously un-monitored parking spots not managed by the parking system, a method of incorporating said un-monitored parking spots so as to become managed by the parking system and thus increase the number of managed parking spots, said method including:
mapping at least one previously un-monitored parking spot;
assigning an identifier to said at least one previously un-monitored parking spot;
evaluating selected details and attributes of said at least one previously un-monitored spot; and
adding said details and attributes of said at least one previously un-monitored spot to a spot database in which are stored details and attributes of parking spots in said pool of parking spots, thereby increasing the number of managed parking spots.

14. A method of displaying vehicles parked in an area, the method comprising:
providing a map of the vehicles parked in said area, said map having an indication for each vehicle; and
receiving at least one visible detail for each vehicle on said map from a vehicle database; and
marking each vehicle indication on said map with said visible detail.

15. A method of reducing traffic related pollution in a region comprising:
having a pool of parking spots in a region;
receiving a parking request from at least one driver of a vehicle, said parking request including at least a destination;
determining a set of parking spots from said pool in accordance with a number of factors which include:
proximity to the destination, and
spots having a location which will require a minimal driving time of the vehicle, thereby providing minimal air pollution by said vehicle,
providing the set of parking spots to said driver for his selection; and
reserving a selected parking spot for said driver.

16. A method according to claim 15, wherein said region is a venue with poor ventilation.

17. A method according to claim 15, also including the step of receiving information regarding traffic patterns in an area proximate to said destination, and wherein said step of determining includes minimizing the slowing effect of said vehicle on the traffic in the area proximate to said destination, thereby minimizing air pollution caused by said vehicle and/or by traffic in the area proximate to said destination.

18. A method of parking comprising:
having an identification number associated with each of a plurality of parking spots in a pool of parking spots;
for each parking spot, storing ownership information and a set of parking rules having conditions, wherein a portion of said parking rules are defined by an owner of said parking spot;
enabling employees of a regional authority to add other parking rules to a group of said parking spots; and
determining a set of parking spots from said pool which are available, which are within a vicinity of a destination of a driver and whose conditions apply.

19. A method of parking comprising:
having a pool of parking spots, said pool comprising at least on-street parking spots and off-street parking spots;
determining a set of parking spots from said pool which are available within a vicinity of a destination of a driver and whose spot details match at least one detail of a vehicle of said driver stored in a vehicle database;
providing a selection of parking spots for said driver to choose from; and
reserving a selected parking spot for said driver.

20. The method according to claim 19 and wherein said determining comprises filtering said set according to driver preferences.

21. The method according to claim 19 each parking spot has at least one parking rule associated therewith and each said parking rule has a condition and a parking scheme applicable when said condition applies and wherein said determining comprises checking said conditions.

22. A method of displaying vehicles registered as parked in an area, the method comprising:
providing a map of the vehicles registered as parked in said area, said map having an indication for each vehicle; and
receiving at least one visible detail for each vehicle on said map from a vehicle database; and
marking each vehicle indication in said map with said visible detail.

23. The method according to claim 22 wherein said at least one visible detail is one of: a color, a manufacturer, a size and a model of said vehicle.

24. A citywide parking system comprising:
a spot system to at least store details of parking spots in a pool of parking spots of a municipality, said details comprising at least a parking spot identification and to enable editing of at least said spot details by owners and of spot parking schemes of groups of spots by city managers; and
a parking event and reservation manager at least to receive a destination from a driver, to determine a set of parking spots from said pool which are available, within a vicinity of said destination and whose spot details match at least one detail of a vehicle of said driver stored in a vehicle database, and to reserve a selection from said driver of one of said set of parking spots.

25. The system according to claim 24 wherein said vehicle database is in communication with a vehicle registry.

26. The system according to claim 24 and wherein said parking event and reservation manager comprises a suggestion list builder to generate said set of parking spots.

27. The system according to claim 26 and wherein said suggestion list builder comprises a filter to filter said set according to driver preferences.

28. The system according to claim 26 and wherein each said parking spot has a size smaller than a standard car and wherein said suggestion list builder generates a set of parking spots, each formed of multiple parking spots according to a size of said vehicle listed in said vehicle database.

29. The system according to claim 24 and wherein said parking event and reservation manager comprises an event database to store parking events and wherein said parking events comprise at least one of: reservations, parking events, parking releases and violations.

30. The system according to claim 24 and wherein said parking scheme is one of: free, paid and based on supply and demand.

31. The system according to claim 24 and wherein said parking scheme defines duration of parking and wherein said duration is one of: fixed, based on supply and demand and having a minimum or maximum time.

32. The system according to claim 24 and wherein said parking event and reservation manager comprises means to receive said destination from one of: a car computer application, a smart phone application, a tablet, a website, an SMS (short message system) message, an IVR (interactive voice response) system, a call center, a parking station and a parking steward or warden.

33. The system according to claim 24 and wherein said parking event and reservation manager is in communication with a navigation system to navigate said driver to and/or from said reserved parking spot.

34. The system according to claim 33 and wherein said parking event and reservation system comprises means to provide at least one visible detail from said vehicle database of vehicles currently registered as parking in the vicinity of said reserved parking spot to display to said driver in association with their parking locations.

35. The system according to claim 34 and wherein said visible detail is other than a license plate number.

36. The system according to claim 34 and wherein said visible detail is at least one of: color, make and model.

37. The system according to claim 24 and wherein said spots have changeable statuses and wherein said status is at least one of the following: reserved, suggested, occupied, and ReservedByGroup.

38. The system according to claim 24 wherein said owners comprise said municipality and at least one of: lot owners and private owners.

39. A citywide parking system comprising:
a parking event and reservation manager at least to receive a destination from a driver, to determine a set of parking spots from said pool which are available, within a vicinity of said destination and whose spot details match at least one detail of a vehicle of said driver stored in a vehicle database, and to reserve a selection from said driver of one of said set of parking spots;
a suggestion list builder to generate said set of parking spots; and
a rule editor for enabling editing of parking rules for each said parking spot, wherein each said parking rule has a condition and a parking scheme applicable when said condition applies and wherein said suggestion list builder comprises a condition checker.

40. The system according to claim 39 and wherein said condition is defined by at least one of:
information about said spots, information about said vehicle, driver preferences, time, duration and group rules applying to groups of spots.

41. The system according to claim 39 and wherein said rules have priorities associated therewith and wherein said suggestion list builder considers said priorities in determining the order in which said rules are applied.

42. The system according to claim 41 and wherein said suggestion list builder comprises a segment list builder to build a segment list of all applicable rules wherein a later applicable rule replaces an earlier applicable rule for the time period to which it applies.

43. The system according to claim 41 and wherein said rule editor comprises a priority editor accessible by employees of a regional authority for groups of spots.

44. The system according to claim 40 and wherein said group rules pertain to at least one of:
residents, disabled, loading and unloading, VIP and embassy parking.

45. A parking system comprising:
a parking event and reservation manager at least to receive a destination from a driver, to determine a set of parking spots from a pool of parking spots in a region which are available, within a vicinity of said destination and whose spot details match at least one detail of a vehicle of said driver stored in a vehicle database, and to reserve a selection from said driver of one of said set of parking spots; and
a violation system in communication with a region violation system to receive violation reports at least from drivers, to provide a map to a parking warden with visual indications of vehicles in spots registered as Occupied in a spot database in a predetermined geographical area and to receive an indication from said warden of a currently available spot that is currently registered as being occupied.

46. The system according to claim 45 and wherein said violation system comprises means to receive a report reporting that said reserved parking spot is occupied and to update a reputation indication of said driver upon receipt of a violation authorization from said parking warden.

47. The system according to claim 46 and wherein said violation system comprises means to activate said parking event and reservation manager to provide a new parking spot to said driver when said driver reports that said selected parking spot is occupied.

48. The system according to claim 46 and wherein said violation system comprises means to show a city warden at least one visible detail from said vehicle database of vehicles currently registered as parking in the vicinity of said parking warden.

49. The system according to claim 48 and wherein said visible detail is other than a license plate number.

50. The method according to claim 18 and also comprising redirecting a driver whose parking spot is occupied by a violator, to a different parking spot.

51. The method according to claim 50 and also comprising redirecting a driver to an alternate location fitting his needs.

52. The method according to claim 50 and also comprising any one of:
reminding a driver to move said vehicle, before the time to park finishes; and offering time extensions to said driver.

53. The method according to claim 18 and also comprising receiving status information from said driver via one of: said driver and a GPS indication.

54. The method according to claim 18 and also comprising storing queue information when a driver's request cannot be fulfilled.

55. The system according to claim 26 and also comprising a queue database to store queue information when a driver's request cannot be fulfilled.

56. The system according to claim 29 and wherein said parking event and reservation manager comprises an analyzer to generate at least one of the following statistics:: waiting time for allocation of a cell, number of cells available, expected costs of parking and demand at a given time, etc.

57. The system according to claim 24 and wherein said parking event and reservation manager comprises an analyzer to generate at least one of the following statistics:
real-time updates of parking status for all parking spots in said region;
real-time updates of supply and demand for parking; and
offline statistical analysis of past parking behavior.

58. The system according to claim 45 and also comprising means to distribute revenues from parking violations at least between a regional authority and the person offended by the violation.
